(19) United States
(12) Patent Application Publication
(10) Pub. No.: US 2006/0199646 A1
(43) Pub. Date: Sep. 7, 2006

(54) Game apparatus and game system

(75) Inventor: Junichi Kogo, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: ARUZE Corp., Tokyo (JP)

(21) Appl. No.: 11/358,709

(22) Filed: Feb. 22, 2006

(30) Foreign Application Priority Data
Feb. 24, 2005 (JP) 2005-049174

(51) Int. Cl. A63F 13/00

(52) U.S. Cl. 463/43

(57) ABSTRACT

When a power supply of a typing game apparatus constituting a game system is turned on, the typing game apparatus requests a server to transmit ranking data. The server creates ranking data of song data from the number of times of use and the number of apparatuses using song data for each of the song data and transmits the ranking data to the typing game apparatus. On the other hand, the typing game apparatus having received the ranking data compares content stored in a song data storage area and the ranking data and retrieves three tunes among songs, which are not stored in the storing area, in order from the top of the ranking data as recommended download data. When an administrator of the typing game apparatus executes operation for requesting download, the recommended download data is delivered.

### RELATED APPLICATION

This application claims the priority of Japanese Patent Application No. 2005-049174 filed on Feb. 24, 2005, which is incorporated herein by reference.

### BACKGROUND OF THE INVENTION

1. Field of the Invention

The present invention relates to a game system, a typing game apparatus, and a server that can strictly perform data management for data for which an expiration date is defined.

2. Description of the Related Art

At present, it is possible to transfer a large volume of data according to the development of the communication network. Consequently, data delivery systems such as an on-demand delivery system that provides customers with music data and image data such as movies from a server via the communication network have been developed.

As an example of such data delivery systems, there is a data delivery system described in Japanese Unexamined Patent Publication No. 2004-134880.

According to the progress of the electronic information technology, various kinds of games have been developed. A large number of games using the communication network have also been developed.

In such games using the communication network, game data is often delivered through the communication network in the same manner as the music data and the image data.

For example, in a multiplayer network role-playing game, which is a type of a game played on a personal computer or the like, game data is delivered from a server through the communication network, whereby areas where a player can go on a venture are expanded and new items are added.

In the field of game apparatuses for business use, a music game in which a player operates a game apparatus to have a song played gains popularity. In such a music game, since a game is played according to a song selected by the player, it is also possible to deliver song data used for the music game through the communication network.

However, in a game apparatus, since a capacity of a storage device for storing game data is limited, it is difficult to store a large number of game data in the game apparatus itself. Therefore, an administrator of the game apparatus has to carefully select game data to be delivered.

In particular, in the game apparatus for business use in which the music game is executed, popularity of song data directly leads to profits generated from the game apparatus for business use. Thus, it is necessary to carefully select song data to be delivered.

Nevertheless, in general, content of the song data delivered in such a game apparatus cannot be grasped until a game based on the song data is executed after the song data is delivered. Therefore, when the administrator of the game apparatus selects song data to be delivered, unless the administrator can learn reputation of a song of the song data in the game business and among people in the same business who use the song earlier, the administrator has to determine song data to be delivered according to only the administrator's own judgment.

Therefore, even if identical game apparatuses are installed in shops, a large difference occurs in profits generated from the game apparatuses between the shops having the game apparatuses to which popular songs are delivered and the shops to which less popular songs are often delivered.

### SUMMARY OF THE INVENTION

The invention has been devised in view of the problem and it is an object of the invention to provide, as a game apparatus and a game system capable of executing games using song data, the game apparatus and the game system that can make the game apparatus attractive by delivering song data popular among players and improve profits derived from the game apparatus.

In order to attain the object, according to a first aspect of the invention, there is provided a game apparatus (e.g., a typing game apparatus 1) including: display sections (e.g., a first liquid crystal display 4 and a second liquid crystal display 5) that display images; a storage section (e.g., an HDD 20) that stores data related to a game including song data; a game controller (e.g., a CPU 10) that controls progress of the game based on the song data; a communication section (e.g., a game communication section 25) that makes connection to a server (e.g., a server 80) in which a plurality of song data are stored to be deliverable; and an operation section (e.g., a keyboard 3) on which operation related to the game is performed. The game apparatus includes a request signal transmitting section (e.g., the CPU 10) that transmits a request signal for delivery of song data, which corresponds to a high rank in ranking data in which song data are ranked on the basis of a predetermined condition, among song data not stored in the storage section to the server.

According to a second aspect of the invention, there is provided a game system (e.g., a game system 100) including: the game apparatus (e.g., the typing game apparatus 1) according to the first aspect of the invention; and a server (e.g., a server 80) having a server communication section (e.g., a server communication section 83) that allows to transmit data to and receive data from the game apparatus and a storage device (e.g., a server storage area 85) having stored therein a plurality of song data. The game apparatus (e.g., the typing game apparatus 1) transmits information on use of the song data to the server (e.g., the server 80) via the communication section (e.g., the game communication section 25) according to execution of a game based on the song data. The server (e.g., the server 80) includes: a ranking data creating section (e.g., a server CPU 81) that creates the ranking data on the basis of information on use of the song data stored in the storage device (e.g., the server storage area 85); and a song data delivering section (e.g., the server CPU 81) that delivers requested song data on the basis of the request signal.

In the game apparatus and the game system of the invention, according to execution of a game based on song data, the game apparatus transmits information on use of the song data to the server via the communication section. The server creates the ranking data using the ranking data creating section on the basis of information on use of song data stored in the storage device and transmits the ranking data to the game apparatus.

The game apparatus having received the ranking data transmits, using the request signal transmitting section, a request signal for delivery of song data, which corresponds to a high rank in the ranking data in which song data are ranked on the basis of the use information, among song data not stored in the storage section to the server.

On the other hand, the server having received the request signal delivers, using the song data delivering section, the requested song data on the basis of the request signal.

Consequently, the song data, which is not stored in the storage section and corresponds to a high rank in the ranking data based on the use information, is stored in the storage section of the game apparatus. Thus, song data corresponding to a high rank in the ranking data according to the use information, that is, song data popular among players is stored. As a result, since it is possible to execute a game on the basis of popular song data, it is possible to make the game apparatus attractive.

Therefore, according to the invention, it is possible to improve an operating ratio of the game apparatus and improve profits generated from the game apparatus.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE INVENTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

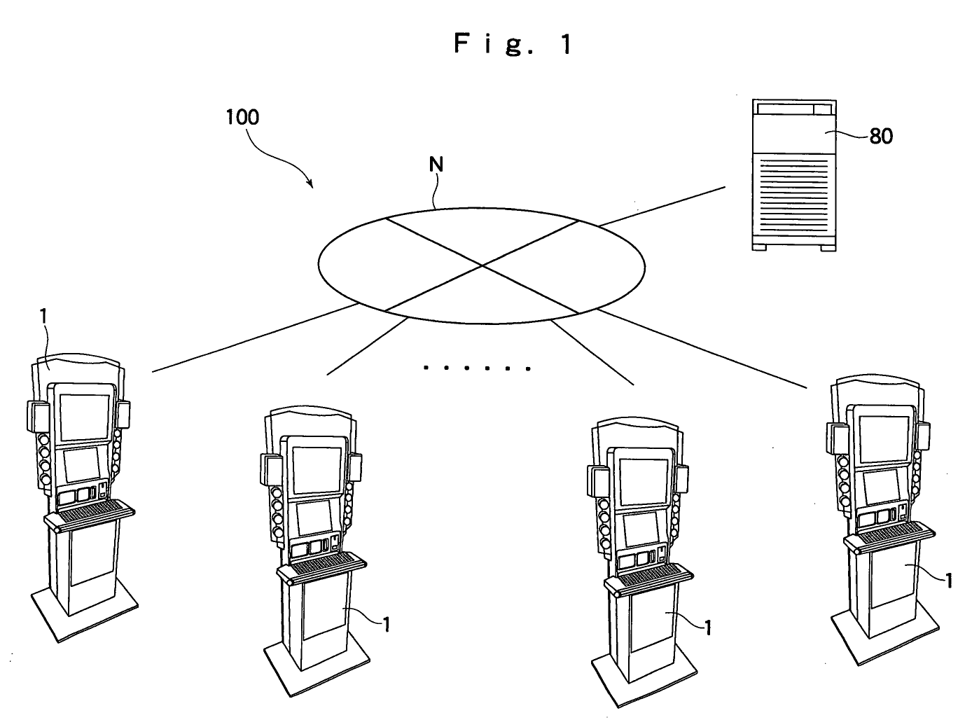

FIG. 1 is a diagram explaining a game system according to an embodiment of the invention;

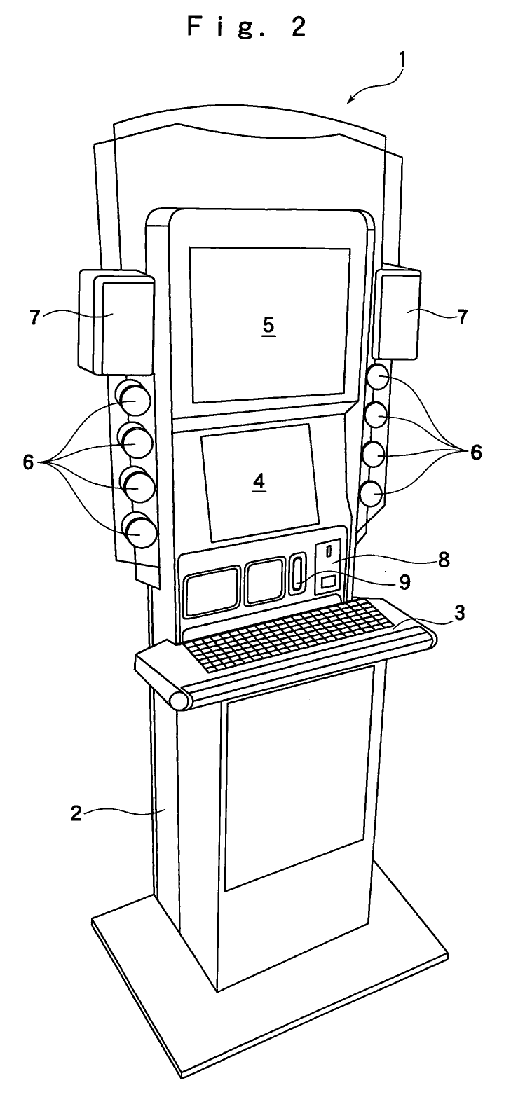

FIG. 2 is an external perspective view of a typing game apparatus constituting the game system according to the embodiment;

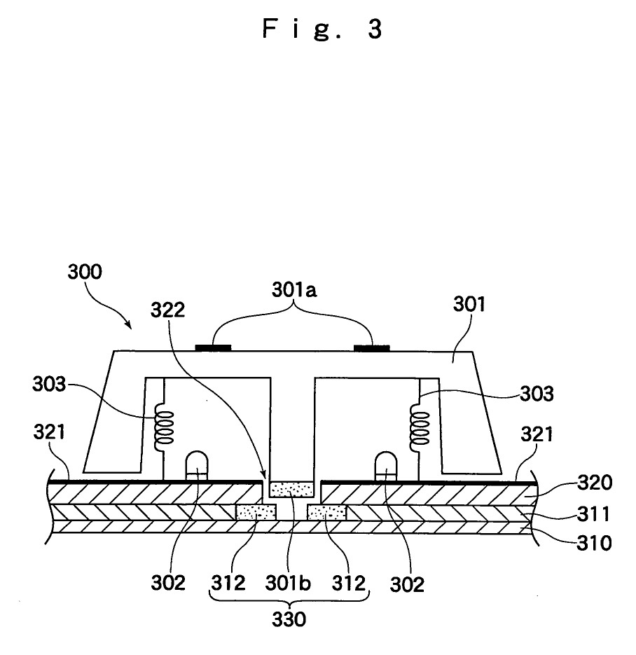

FIG. 3 is a sectional view for explaining a key disposed on a keyboard of the typing game apparatus according to the embodiment;

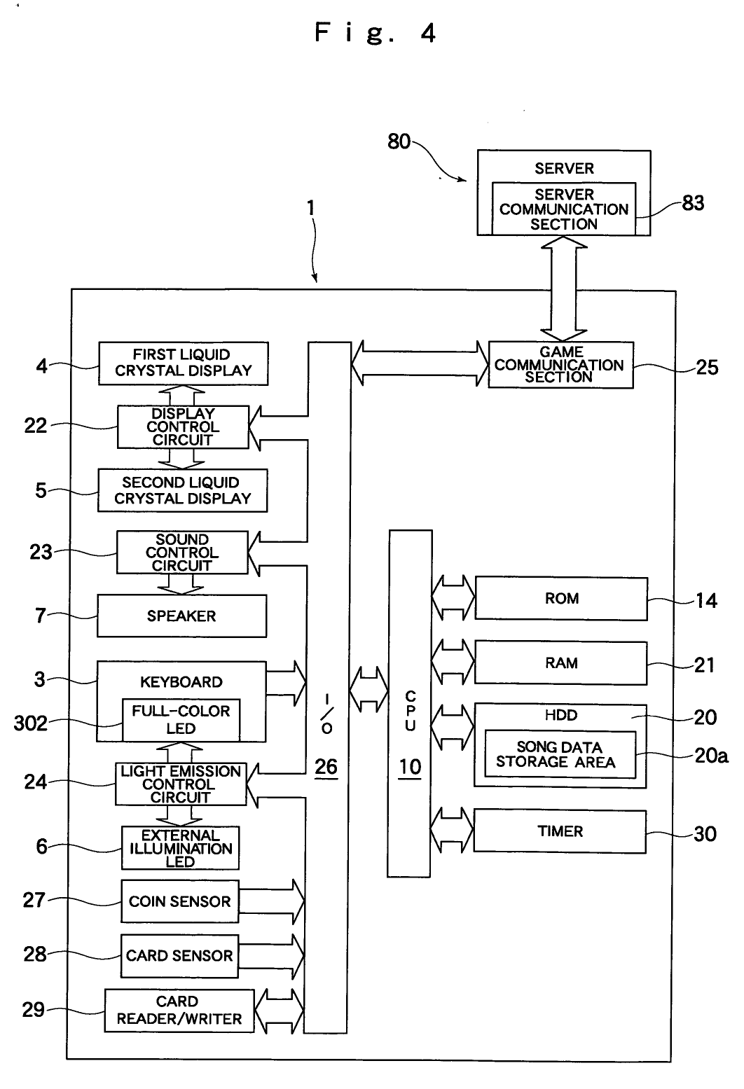

FIG. 4 is a block diagram of a control system for the typing game apparatus according to the embodiment;

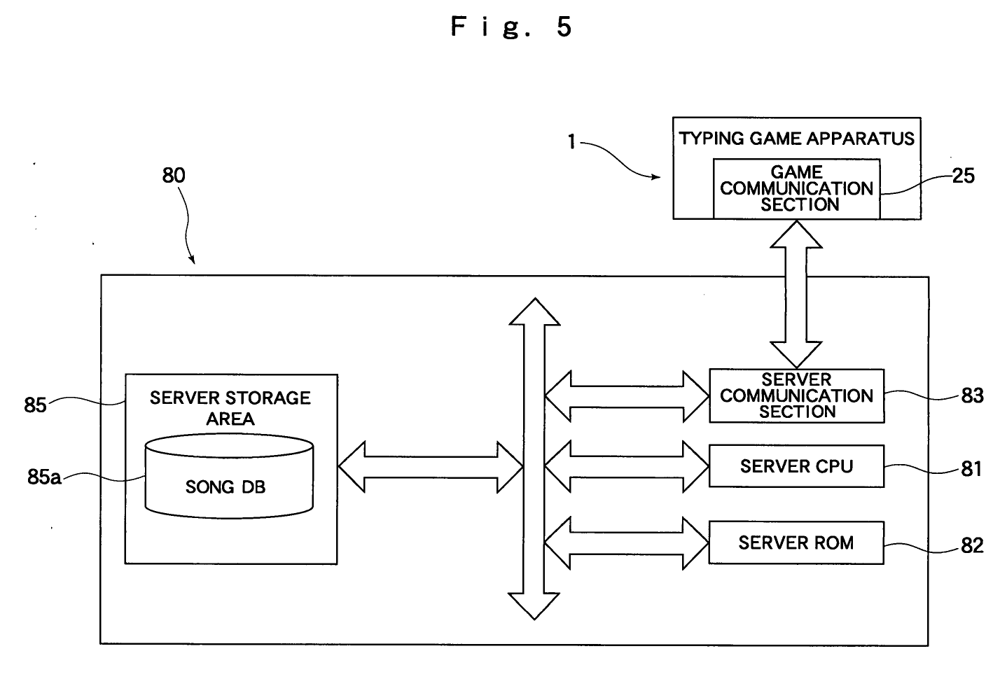

FIG. 5 is a block diagram of a control system for a server according to the embodiment;

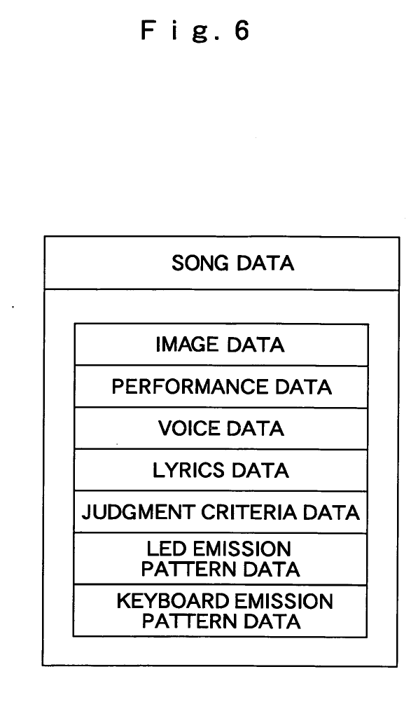

FIG. 6 is a diagram for explaining song data stored in the typing game apparatus and the server according to the embodiment;

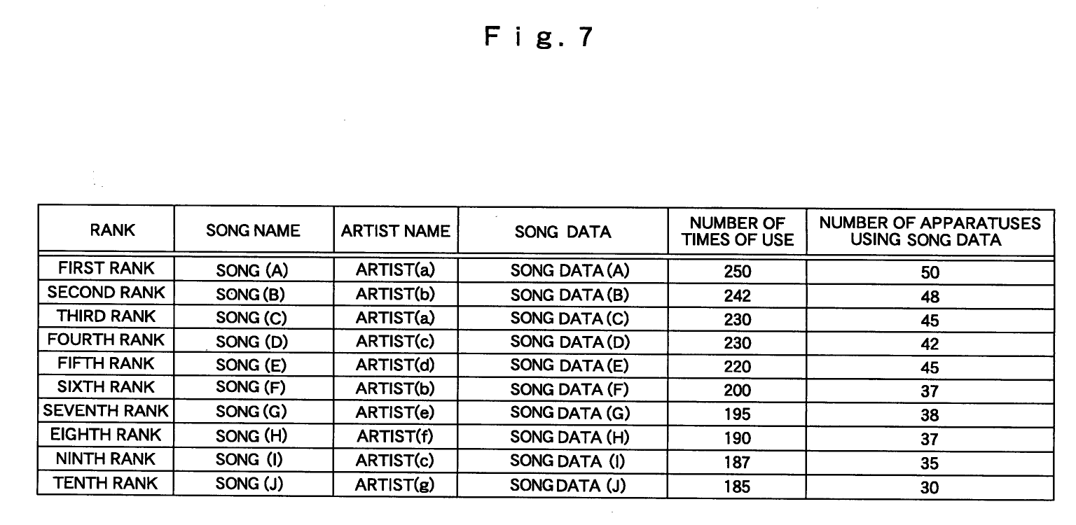

FIG. 7 is a diagram for explaining ranking data created in the server according to the embodiment;

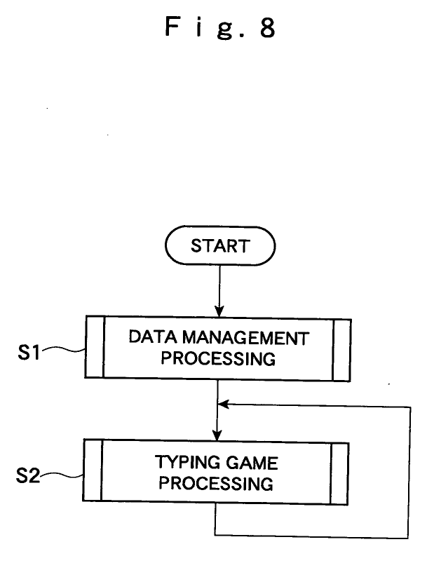

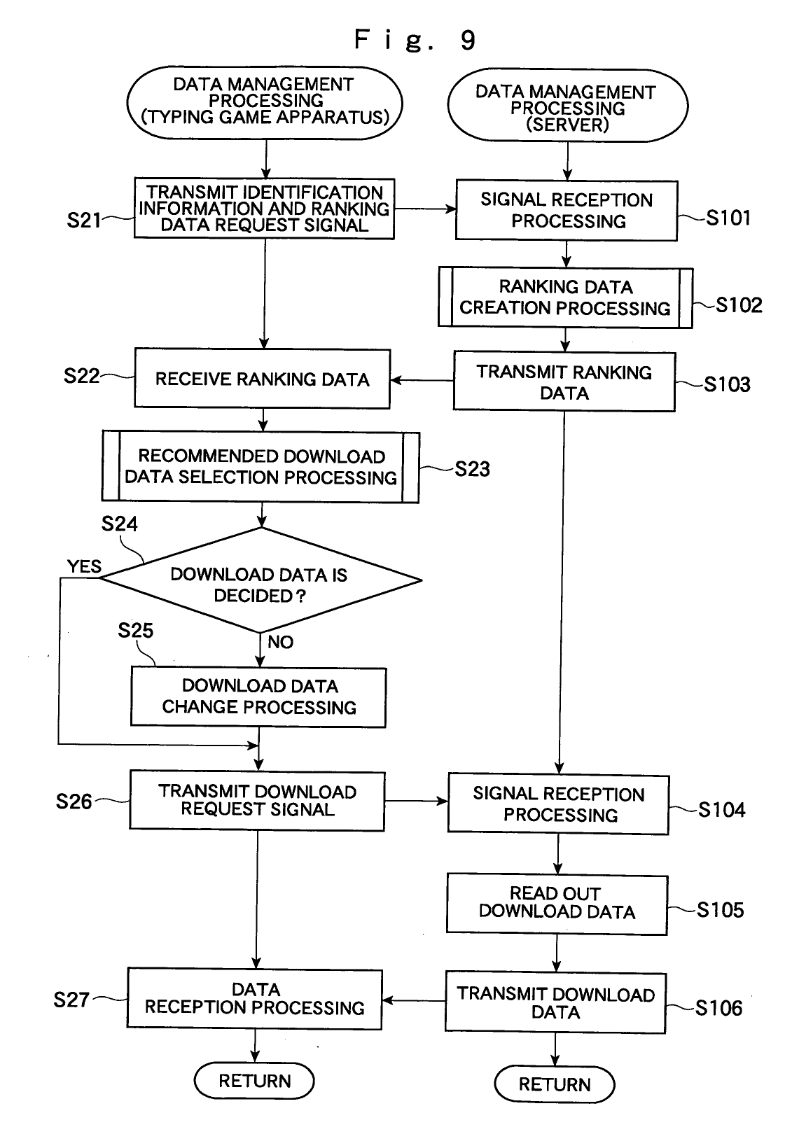

FIG. 8 is a flowchart of a main control program for the typing game apparatus according to the embodiment;

FIG. 9 is a flowchart of a data management processing program for the game system according to the embodiment;

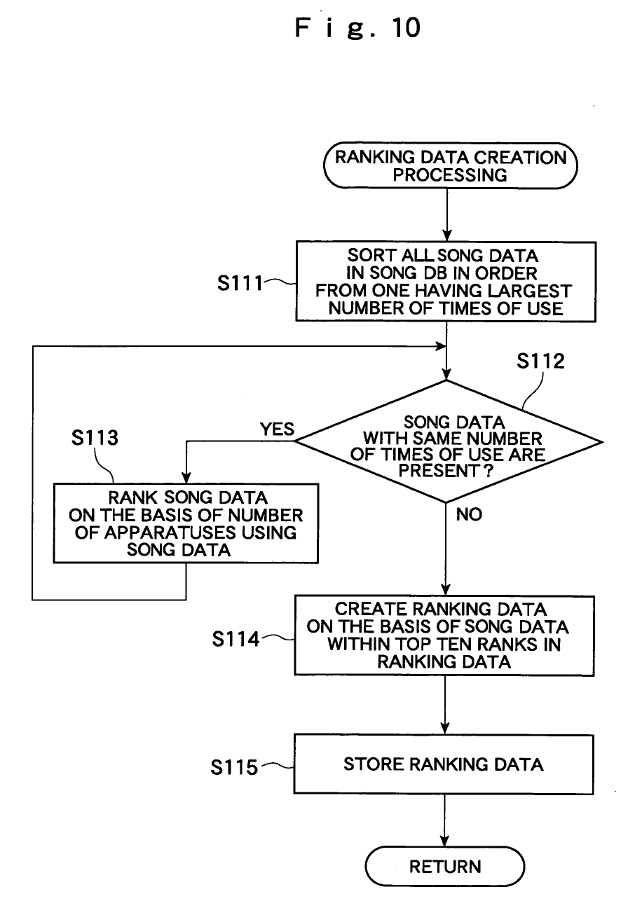

FIG. 10 is a flowchart of a ranking data creation processing program for the server according to the embodiment;

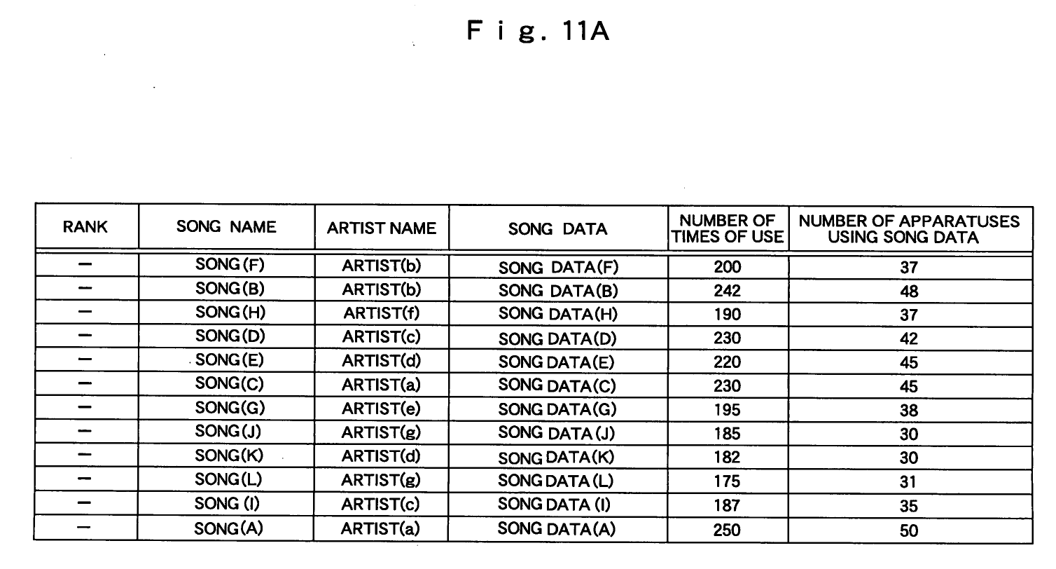

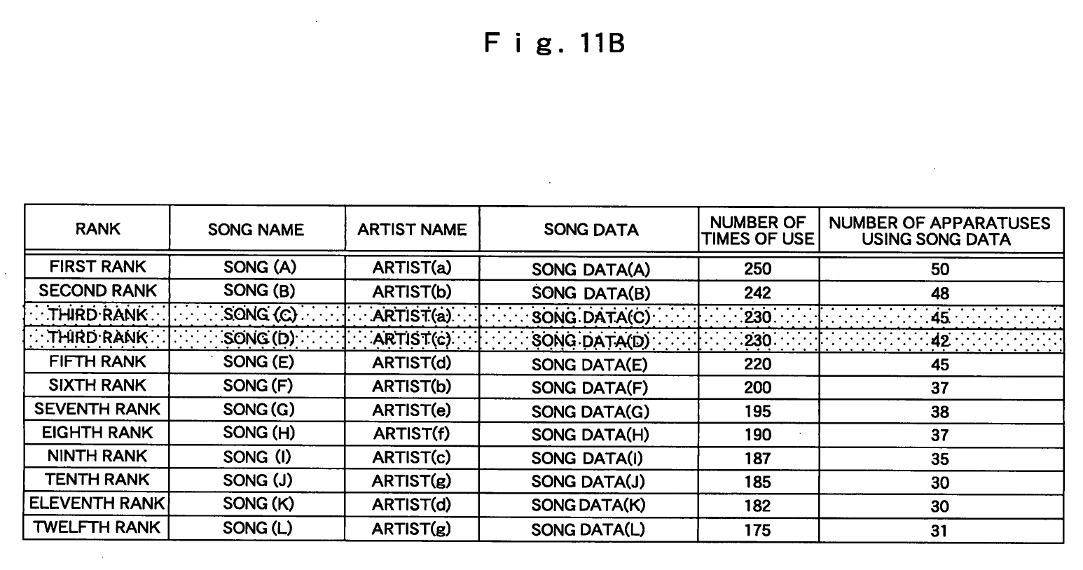

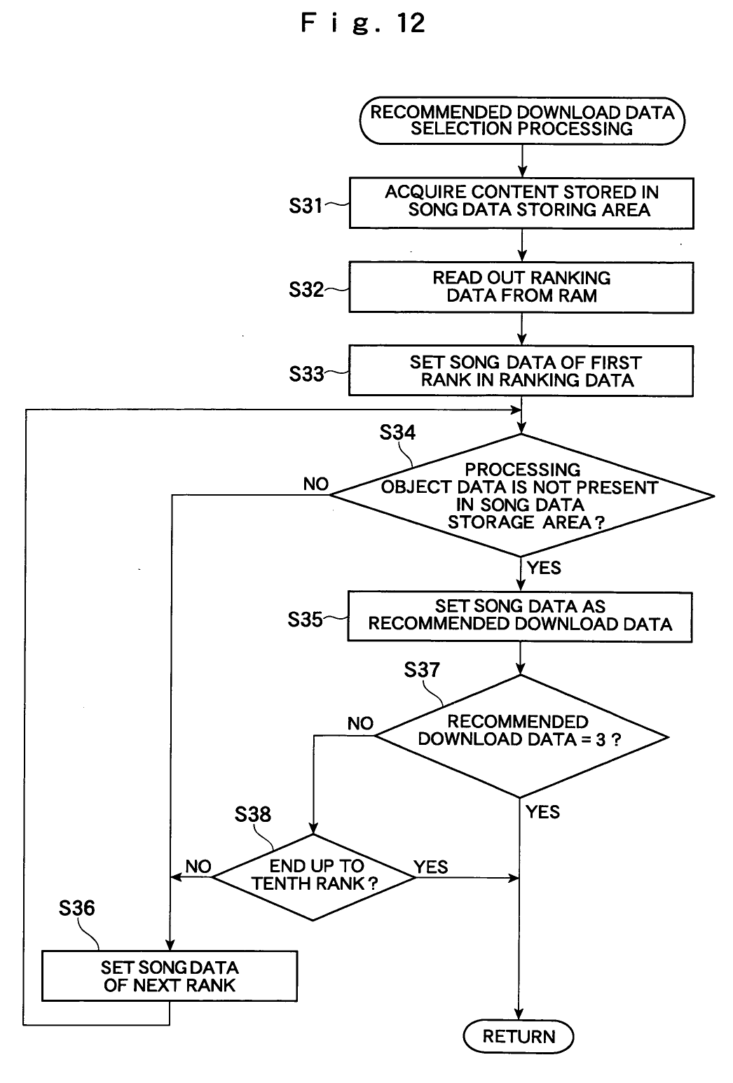

FIGS. 11A and 11B are diagrams for explaining ranking data creation processing according to the embodiment;

FIG. 12 is a flowchart of a recommended download data selection processing program for the typing game apparatus according to the embodiment;

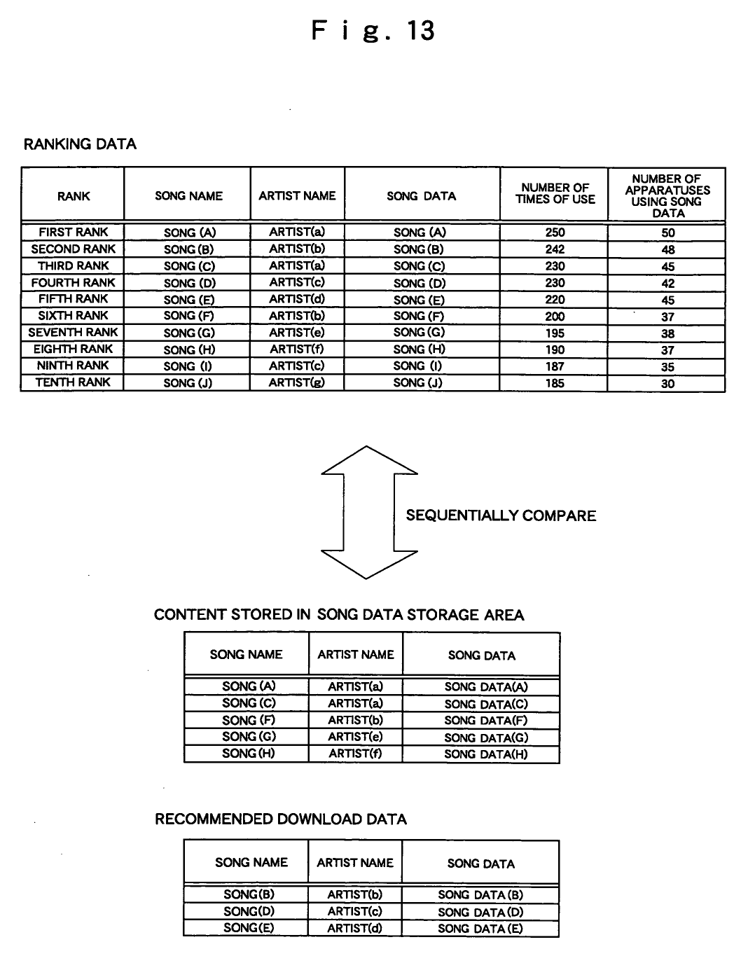

FIG. 13 is a diagram for explaining recommended download data selection processing according to the embodiment;

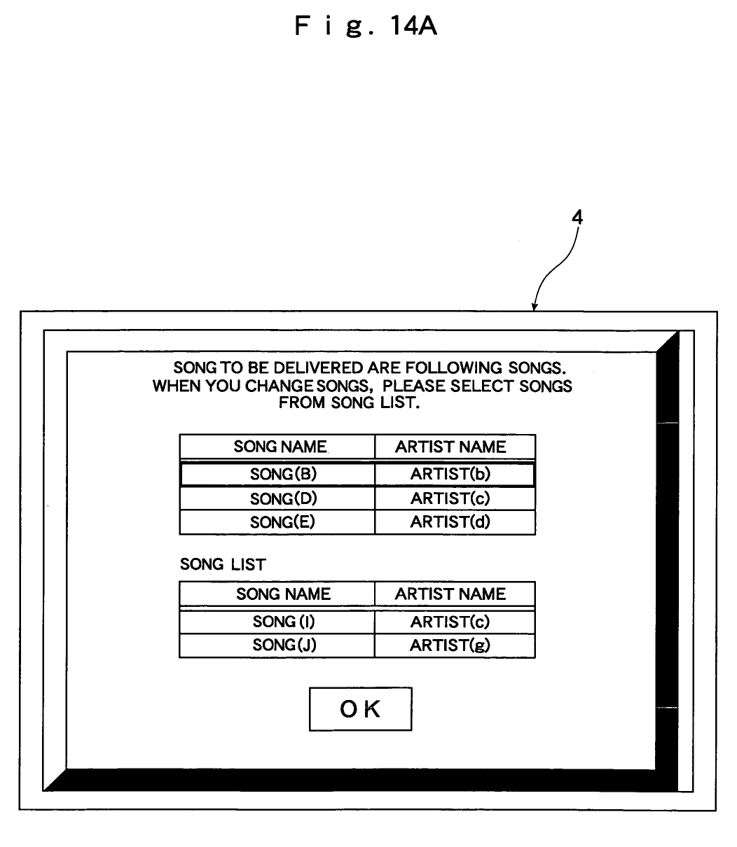

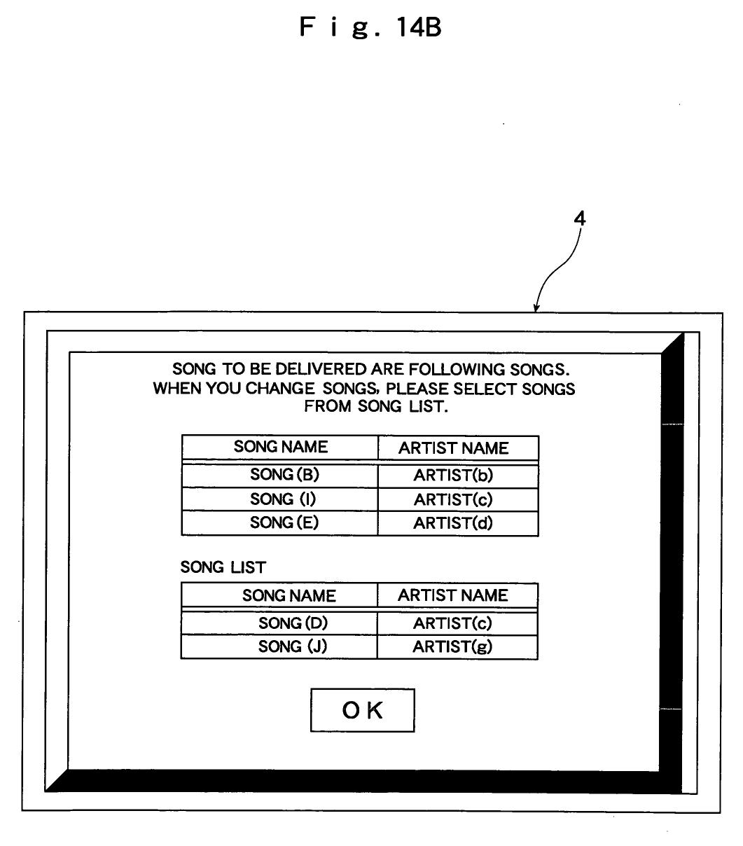

FIGS. 14A and 14B are diagrams for explaining a confirmation display screen and download data change processing in the typing game apparatus according to the embodiment;

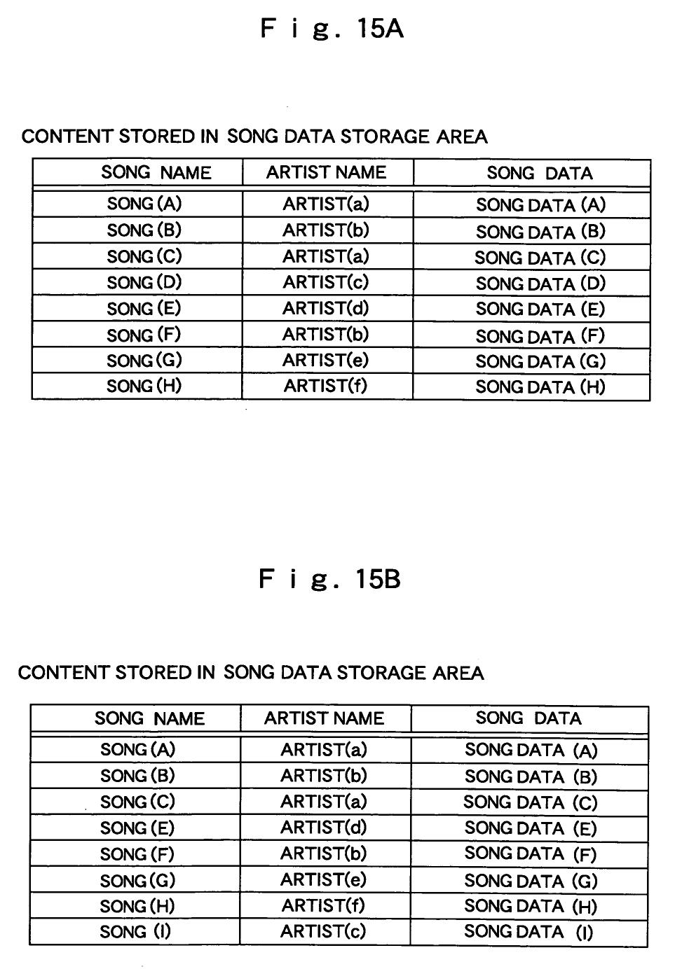

FIGS. 15A and 15B are diagrams for explaining a song data storage area at the time of end of data update processing of the typing game apparatus according to the embodiment, wherein FIG. 15A shows a case in which recommended download data is downloaded and FIG. 15B shows a case in which the recommended download data is changed according to download data change processing;

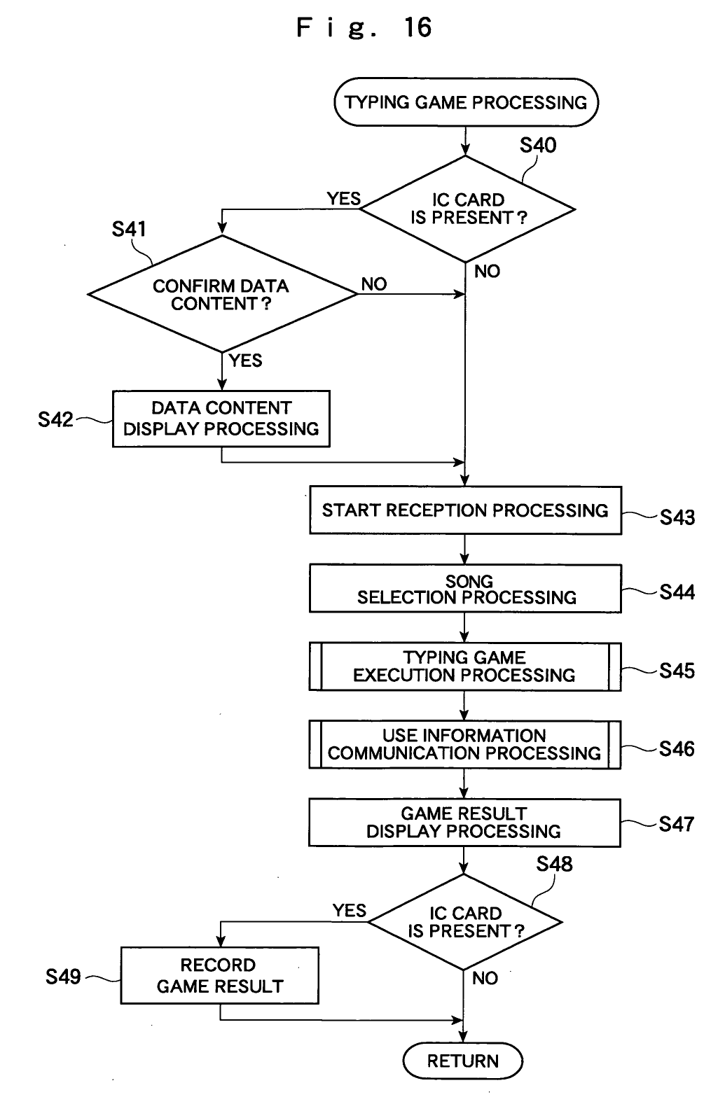

FIG. 16 is a flowchart of a typing game processing program for the typing game apparatus according to the embodiment;

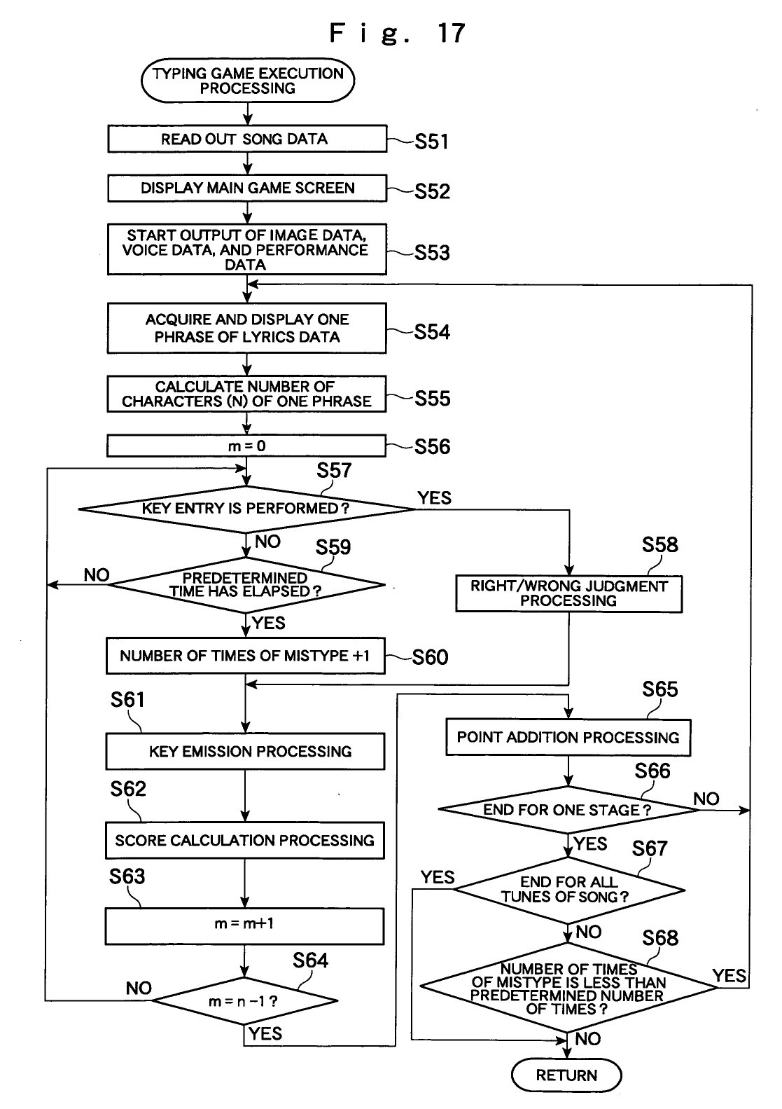

FIG. 17 is a flowchart of a typing game execution processing program for the typing game apparatus according to the embodiment;

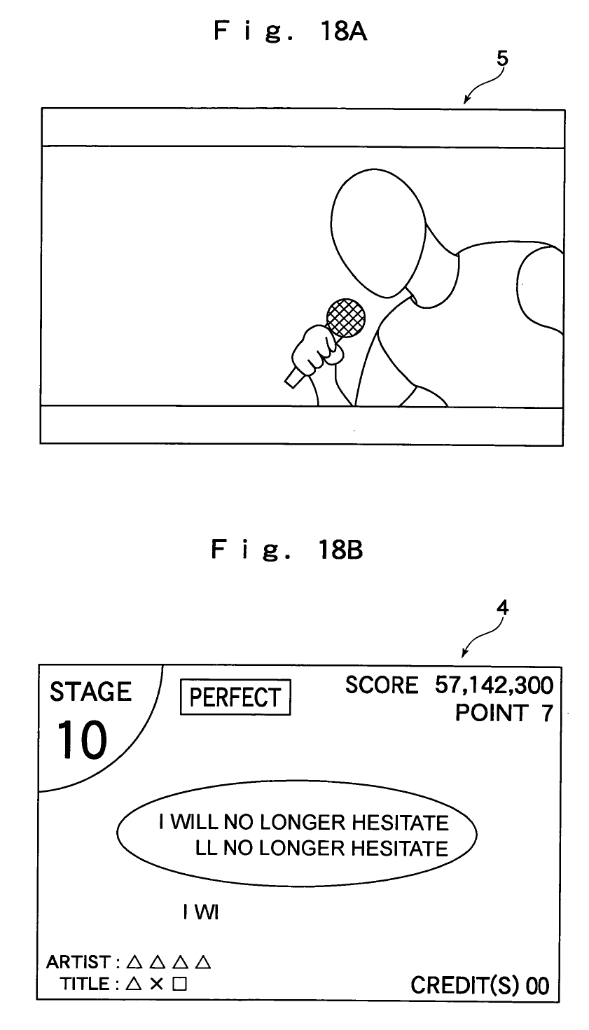

FIGS. 18A and 18B are display examples (1) of respective liquid crystal displays during execution of a typing game according to the embodiment, wherein FIG. 18A shows a display example of a second liquid crystal display and FIG. 18B shows a display example of a first liquid crystal display; and

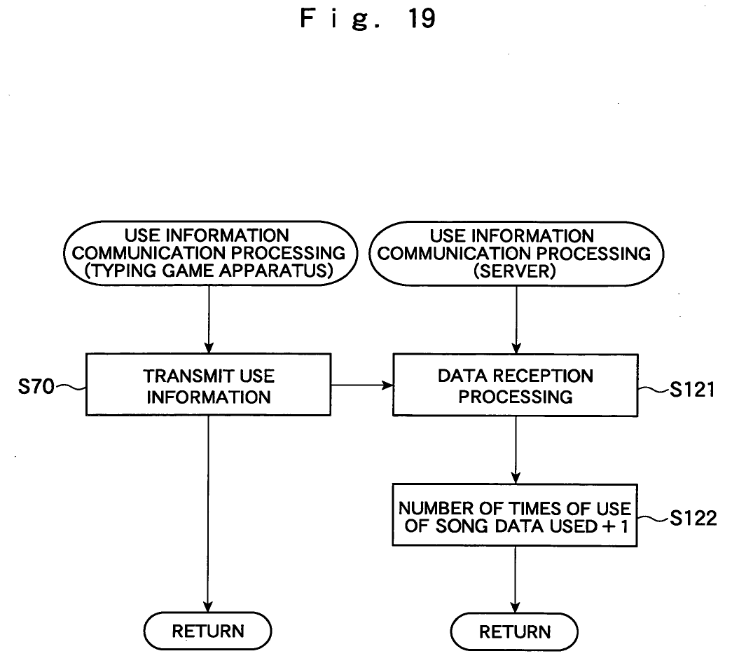

FIG. 19 is a flowchart of a use information communication processing program for the game system according to the embodiment.

### DETAILED DESCRIPTION OF THE INVENTION

An embodiment in which a game system according to the invention is embodied will be explained in detail with reference to the accompanying drawings.

First, a constitution of the game system according to this embodiment will be explained with reference to the drawings. FIG. 1 is a diagram for explaining an example of the constitution of the game system according to this embodiment.

A game system 100 according to the invention includes a large number of typing game apparatuses 1 and a server 80. These typing game apparatuses 1 and the server 80 are connected through a network N. Consequently, the typing game apparatuses 1 and the server 80 function as the game system 100 according to this embodiment.

In each of the typing game apparatuses 1, a game communication section 25 described later is disposed. Thus, the typing game apparatus 1 can perform two-way communication with the server 80 by radio. On the other hand, a server communication section 83 described later is disposed in the server 80. Thus, the server 80 is capable of performing transmission and reception of data to and from each of the typing game apparatuses 1 by radio.

In the game system 100 according to this embodiment, the typing game apparatuses 1 and the server 80 are connected to the network N and transmission and reception of data are performed between the typing game apparatuses 1 and the server 80 by radio. However, means for the connection to the network N and the transmission and reception of data is not limited to radio. The connection to the network N and the transmission and reception of data may be performed by wire.

A typing game apparatus according to this embodiment will be explained in detail with reference to FIGS. 2 to 4.

First, a schematic constitution of the typing game apparatus 1 will be explained in detail with reference to FIG. 2. FIG. 2 is an external perspective view of the typing game apparatus 1.

In the typing game apparatus 1 according to this embodiment, a typing game is performed with a method of entering lyrics of a song. When the typing game is started, performance data of accompaniment music of the song and voice data of singing voice of a singer of the song are reproduced. As the reproduction of the performance data and the voice data of the song progresses, lyrics of the song are displayed phrase by phrase as a character string that a player should enter.

By entering the lyrics for one phrase displayed with a keyboard 3, the typing game progresses. When the song ends, a result of the typing game is calculated on the basis of elements related to typing such as accuracy of typing and entry timing. In the typing game in the typing game apparatus 1, players can compete with one another concerning a level of a typing skill while enjoying the song performed during the game.

As shown in FIG. 2, in the typing game apparatus 1 according to this embodiment, the keyboard 3, a first liquid crystal display 4, a second liquid crystal display 5, and the like are disposed in an body housing 2.

The first liquid crystal display 4 is disposed on a front side of the body housing 2 of the typing game apparatus 1. The first liquid crystal display 4 is a so-called liquid crystal display and is disposed to be slightly tilted backward from the front side of the body housing 2.

When the typing game is executed, lyrics data of a song to be reproduced is displayed on the first liquid crystal display 4. In addition, an entry result of entry performed by a player using the keyboard 3 and indications related to the play of the typing game such as a score obtained according to the entry result are displayed on the first liquid crystal display 4.

The second liquid crystal display 5 is disposed above the first liquid crystal display 4 in the body housing 2. The second liquid crystal display 5 is also a so-called liquid crystal display like the first liquid crystal display 4.

When the typing game is executed, a video related to a song to be reproduced is displayed on the second liquid crystal display 5. For example, when a song of a certain artist is reproduced, a promotion video (hereinafter referred to as PV) related to the song of the artist is displayed.

Speakers 7 are disposed on both left and right sides of the second liquid crystal display 5. The speakers 7 are devices that emit sounds of a song or the like in the typing game apparatus 1. When the typing game is executed, the speakers 7 emit sounds on the basis of voice data and performance data of a song to be reproduced.

Four external illumination LEDs 6 are disposed on each of left and right sides of the body housing 2. The external illumination LEDs 6 are formed of LEDs capable of lighting in full-color and used for performing various kinds of lighting effects according to a song to be reproduced by the typing game apparatus 1. For example, as the lighting effect, it is possible to perform effect for changing lighting colors of the eight external illumination LEDs 6 in total, respectively, effect for changing a lighting color according to a fixed rule, effect according to turn-on/turn-off forms of the external illumination LEDs 6, and the like.

On the other hand, a coin slot 8 and a card inserting port 9 are disposed below the first liquid crystal display 4 disposed on the front side of the body housing 2. The coin slot 8 is a slot for collecting, when the typing game is executed, a coin as payment for the typing game. A coin sensor 27 described later is disposed inside the coin slot 8. When an inputted coin is detected by the coin sensor 27, it is possible to execute the typing game in the typing game apparatus 1.

The card inserting port 9 is a portion in which an IC card (not shown), in which a game result of the typing game is recorded, is inserted. A card sensor 28 and a card reader/writer 29 described later are disposed inside the card inserting port 9. Therefore, when the IC card is inserted in the card inserting port 9, the IC card is detected by the card sensor 28 and data of a game result of the typing game is read out from or written in an IC chip built in the IC card by the card reader/writer 29.

The keyboard 3 is disposed in the front of the body housing 2 to project forward. The keyboard 3 is a module for depressing keys corresponding to characters, signs, numbers, and the like on which a plurality of keys 300 such as “A to Z” “A to N in hiragana characters”, “0 to 9”, a period, a comma, a determine key, and the like are arranged. The keyboard 3 also serves as a module for instructing determination of selection of a song and a character type, start of execution of the typing game, and the like.

Therefore, when the typing game is executed in the typing game apparatus 1, the game progresses as the keys 300 corresponding to a character string (one phrase of lyrics) displayed on the first liquid crystal display 4 are depressed.

A constitution of the keyboard 3 will be explained. FIG. 3 is a schematic sectional view showing any one of the a plurality of keys 300 provided in the keyboard 3 in a cut state.

As shown in FIG. 3, the key 300 includes a base plate 310, a switch circuit board 311, a light-emitting circuit board 320, a key top 301, and urging mechanisms 303.

A pair of electrodes 312 arranged right below near the center of the key top 301 are provided in the switch circuit board 311 laid on the base plate 310.

An opening 322 for exposing the pair of electrodes 312 is provided in the light-emitting circuit board 320 laid on the switch circuit board 311. LEDs 302 that can be lit in full color are provided around the opening 322.

The urging mechanisms 303 are provided between the light-emitting circuit board 320 and the key top 301. The key top 301 is urged to the opposite side of the switch circuit board 311 by the urging mechanism 303. Moreover, near the center of the key top 301, an electrode 301b is provided to protrude to the side of the switch circuit board 311. Therefore, if the key top 301 is depressed, it is possible to bring the electrode 301b protrudingly provided in the key top 301 into contact with the pair of electrodes 312 provided in the switch circuit board 311. Thus, it is possible to communicate the depression of the key top 301 as an electric signal flowing to the switch circuit board 311. Therefore, these three electrodes 301b and 312 constitute a key switch 330.

The urging mechanisms 303 may be formed of only an elastic member or may be formed of an elastic member and a bridging mechanism. A constitution of the urging mechanisms 303 is not limited.

The key top 301 is formed of a material having translucency (e.g., transparent acryl or transparent plastic). Key information 301a such as characters, numbers, and signs are printed in black on a flat portion on the opposite side of the switch circuit board 311. Moreover, a surface of the light-emitting circuit board 320 on the key top 301 side is also printed in black.

Therefore, while the LEDs 302 are off, the translucent key top 301 shows black that is the color of the surface of the light-emitting circuit board 320. Thus, it is difficult to recognize the key information 301a printed in black on the key top 301 showing black.

On the other hand, while the LED 302 is on, the translucent key top 301 shows a color of the LED 302 lit. Thus, it is easy to recognize the key information 301a printed in black on the key top 301 showing the color.

In the keyboard 3, the key switch 330 in the key 300 is connected to a not-shown transmission circuit. The transmission circuit is connected to the CPU 10 of the typing game apparatus 1 via an interface section 26 (hereinafter referred to as I/O) described later. Therefore, since an electric signal from the key switch 330 of the key 300 depressed is transmitted to the CPU 10 via the transmission circuit, it is possible to specify the depressed key 300. The transmission circuit is mounted on the switch circuit board 311.

In the keyboard 3, the LED 302 in the key 300 is connected to a light emission control circuit 24. The light emission control circuit 24 is connected to the CPU 10 via the I/O 26. Therefore, the CPU 10 can light the LEDs 302 in the key 300 in a specified color via the light emission control circuit 24.

In FIG. 3, one key 300 is explained above. However, the other keys 300 arranged on the keyboard 3 have the same constitution and function.

A control system for the typing game apparatus 1 will be explained in detail with reference to the drawings. FIG. 4 is a control system block diagram of the typing game apparatus 1.

As shown in FIG. 4, the control system for the typing game apparatus 1 includes the CPU 10 that manages various kinds of control such as a play processing operation in the typing game apparatus 1 and a peripheral device (an actuator) electrically connected to the CPU 10.

The CPU 10 is a central processing unit that performs arithmetic processing in accordance with various commands. The I/O 26 is a connecting section that electrically connects the keyboard 3, the first liquid crystal display 4, the second liquid crystal display 5, the speakers 7, and the like and the CPU 10 directly or indirectly. A ROM 14 is a nonvolatile read-only memory in which an arithmetic operation program for implementing a flowchart described later is stored. A RAM 21 is a volatile readout or writing memory for temporarily storing data that is used when the CPU 10 executes a program. The RAM 21 temporarily stores song data stored in the HDD 20.

The HDD 20 is a storage device in which song data used at the time of execution of the typing game in the typing game apparatus 1 is stored. A song data storage area 20a, in which a plurality of song data are stored, is formed in the HDD 20.

Ranking data described later received from the server 80 is stored in the HDD 20 via the game communication section 25.

The song data stored in the song data storage area 20a will be explained in detail with reference to the drawings. FIG. 6 is a diagram for explaining a constitution of the song data.

As shown in FIG. 6, the song data used in the typing game apparatus 1 includes image data, performance data, voice data, lyrics data, judgment criteria data, LED emission pattern data, and keyboard emission pattern data.

In the typing game apparatus 1 according to this embodiment, a game to be played is a typing game for entering, while reproducing a song sung by an artist, lyrics of the song. Thus, the data forming the song data corresponds to the song.

The image data forming the song data is data of a PV of the artist corresponding to the song. The performance data is music data of an accompaniment by a musical instrument or the like in the song. The voice data is voice data of singing voice of the artist singing of the song.

The lyrics data forming the song data is document data of lyrics corresponding to the song. When the typing game is executed, the lyrics data is used in displaying lyrics for one phrase on the first liquid crystal display 4.

The judgment criteria data forming the song data is criteria data for right/wrong judgment for the key 300 depressed by a player and right/wrong judgment for key entry timing at the time of execution of the typing game using the song data.

Therefore, when the player performs typing according to criteria of the judgment criteria data, a high score is given to the player. On the other hand, when there is a difference from the criteria of the judgment criteria data, for example, when the key 300 depressed by the player is different from the key 300 defined in the judgment criteria data (so-called miss-touch) or when timing for depressing a key significantly delays from progress of a song, the player cannot acquire a high score at the time when the typing game ends.

The LED emission pattern data and the keyboard emission pattern data forming the song data are effect data in which forms of lighting effect of the typing game apparatus 1 at the time of execution of the typing game using the song data are defined.

In other words, the LED emission pattern data is data of a light emission pattern of the external illumination LEDs 6 that emit light according to progress of a song during execution of the typing game. Therefore, a light emission form of the external illumination LEDs 6 at the time of execution of the typing game using the song data is decided on the basis of the LED emission pattern data. Respective light emission forms (e.g., a light emission color and turn-on/turn-off) of the eight external illumination LEDs 6 are controlled via the light emission control circuit 24 described later.

The keyboard emission pattern data is data of light emission patterns of the LEDs 302 disposed for each of the keys 300 constituting the keyboard 3. Therefore, a light emission form of the LEDs 302 of each of the keys 300 constituting the keyboard 3 is controlled on the basis of the keyboard emission pattern data via the light emission control circuit 24.

As the light emission patterns of the keyboard 3, there are various light emission patterns such as a light emission pattern for assisting key entry by sequentially lighting the keys 300, which should be depressed, in a light emission color different from a light emission color of the entire keyboard 3 for beginners of the typing game and a light emission pattern for changing a light emission color of all the keys 300 disposed on the keyboard 3 according to an image of a song.

Referring back to FIG. 4, the control system for the typing game apparatus 1 will be explained.

The game communication section 25 is a device that changes a signal, which the typing game apparatus 1 should send, to a signal of a transmittable form according to a communication system such as a telephone line or a LAN cable to transmit the signal to the outside and receives a signal sent to the typing game apparatus 1 to restore the signal to a form readable by the typing game apparatus 1. The game communication section 25 is connected to the network N by radio and connected to the server communication section 83 of the server 80 through the network N.

The display control circuit 22 is connected to the CPU 10 via the I/O 26. The display control circuit 22 is used for control of display contents on the first liquid crystal display 4 and the second liquid crystal display 5 according to an arithmetic processing result of the CPU 10. When the typing game is executed, the display control circuit 22 displays the lyrics data forming the song data phrase by phrase on the first liquid crystal display 4. The display control circuit 22 is also used in performing control for, for example, displaying, on the basis of an entry result of the keyboard 3, characters corresponding to content of the entry on the first liquid crystal display 4.

The display control circuit 22 is also used in displaying various effect videos on the second liquid crystal display 5. During execution of the typing game, the display control circuit 22 is also used in performing control for displaying a PV that is image data of the song.

A sound control circuit 23 is connected to the CPU 10 via the I/O 26 and also connected to the speakers 7. When song data is read out while the typing game is executed, performance data and voice data forming the song data are converted into a voice signal by the sound control circuit 23 and outputted from the speakers 7.

The light emission control circuit 24 is connected to the CPU 10 via the I/O 26 and also connected to the external illumination LEDs 6 and the LEDs 302 in each of the keys 300 disposed on the keyboard 3. The light emission control circuit 24 is used in controlling, when song data is read out at the time of execution of the typing game, light emission forms of the external illumination LEDs 6 and the respective LEDs 302 on the basis of the LED emission pattern data and the keyboard emission pattern data forming the song data.

The coin sensor 27 is a sensor that detects a coin used as payment for execution of the typing game. The coin sensor 27 is disposed inside the coin slot 8 and connected to the CPU 10 via the I/O 26. Therefore, the coin sensor 27 transmits a coin input signal to the CPU 10 on the basis of input of coin from the coin slot 8. The CPU 10 allows to execute the typing game by detecting coin input signals for a predetermined number of coins.

The card sensor 28 is a sensor that detects whether an IC chip built-in card (an IC card) is inserted in the card inserting port 9. The card reader/writer 29 is a device that reads out data from and writes data in an IC chip disposed in the IC chip built-in card. Both the card sensor 28 and the card reader/writer 29 are disposed inside the card inserting port 9 and connected to the CPU 10 via the I/O 26. When it is recognized by the card sensor 28 that the IC chip built-in card is inserted, the CPU 10 reads out data from the IC chip or writes data in the IC chip via the card reader/writer 29.

The timer 30 is a timing section and is connected to the CPU 10. The timer 30 is referred to when elapse of a predetermined time is judged.

The server 80 that delivers song data and ranking data to the typing game apparatus 1 as occasion arises will be explained.

The server 80 according to this embodiment includes a server CPU 81, a server ROM 82, a server communication section 83, and a server storage area 85.

The server CPU 81 is a central processing unit that executes a control program in order to perform various kinds of control of the server 80. Therefore, the server CPU 81 executes a ranking data creation processing program stored in the server ROM 82, a communication program for transmission and reception of data and signals to and from the respective typing game apparatuses 1 constituting the game system 100, and the like.

The server ROM 82 is a nonvolatile read-only memory in which a control program for performing various control operations of the server CPU 81 is stored. Therefore, various programs such as a ranking data creation processing program for creating ranking data related to a state of use of song data from a song DB 85a and a communication program are stored in the server ROM 82.

The server communication section 83 is a communication section that performs two-way communication between the server 80 and the typing game apparatus 1 through the network N. In other words, the server communication section 83 is a device that changes data transmitted by the server 80 to a signal of a transmittable form according to a communication form such as a telephone line and a LAN cable to transmit the signal to the outside and receives a signal sent from the typing game apparatus 1 to restore the signal to a form readable by the server 80. The server communication section 83 is connected to the game communication section 25 of the typing game apparatus 1 by radio through the network N.

In the server 80 according to this embodiment, it is possible to deliver song data equivalent to up to three tunes to one typing game apparatus 1 in one access.

The server storage area 85 is a storage section in which various data used in the server 80 are stored. It is possible to add content to and delete content from the server storage area 85. The server storage area 85 is also a storage section that temporarily stores various arithmetic operation results when the control program for the server 80 is executed.

The song DB 85a is formed in the server storage area 85. The plurality of song data are stored in the song DB 85a. It is possible to add and delete song data to and from the song DB 85a. The server 80 can deliver the song data stored in the song DB 85a to the typing game apparatus 1 through the network N.

Therefore, it is possible to deliver new song data to the typing game apparatus 1 by adding song data to the song DB 85a. It is possible to enjoy the typing game executed in the typing game apparatus with a new song.

Data concerning a state of use of song data such as data on the number of times of use and data on the number of apparatuses using song data are stored in the song DB 85a for each song data. The data on the number of times of use is data indicating the number of times the typing game is executed using song data in the typing game apparatuses 1 constituting the game system 100. The data on the number of apparatuses using song data is data indicating the number of times song data is delivered to the typing game apparatuses 1 constituting the game system 100. The data on the number of times of use and the data on the number of apparatuses using song data are used in generating ranking data transmitted to the typing game apparatuses 1 (see FIG. 7).

Operations of the typing game apparatus 1 will be explained with reference to the drawings. First, a main control program for the typing game apparatus 1 will be explained in detail with reference to FIG. 8. FIG. 8 is a flowchart of the main control program for the typing game apparatus 1.

As shown in FIG. 8, in the typing game apparatus 1 according to this embodiment, when a power supply of the typing game apparatus 1 is turned on, data management processing (S1) is performed. The data management processing (S1) is processing for receiving delivery of song data stored in the song DB 85a of the server 80. Since the data management processing (S1) will be explained in detail later with reference to the drawings, a detailed explanation of the data management processing (S1) in this section is omitted.

After the data management processing (S1) ends, the CPU 10 shifts to typing game processing (S2). The typing game processing (S2) is processing related to execution of the typing game. Since the typing game processing will be explained in detail later with reference to the drawings, an explanation of the typing game processing in this section is omitted.

After the typing game processing (S2) ends, that is, when the typing game is performed once, the CPU 10 returns to S2 and receives execution of the typing game.

Respective kinds of processing forming the main control program for the typing game apparatus 1 will be explained in detail with reference to the drawings.

First, the data management processing (S1) that is performed first when the main control program for the typing game apparatus 1 is executed will be explained in detail with reference to FIG. 9 to FIGS. 15A and 15B. FIG. 9 is a flowchart of the data management processing program.

When the power supply of the typing game apparatus 1 is turned on and the data management processing (S1) is started, first, the CPU 10 transmits a ranking data request signal, which requests ranking data, to the server 80 (S21) together with identification information identifying the typing game apparatus 1. The ranking data indicates a state of use of song data in the game system 100.

On the other hand, when the server CPU 81 receives the ranking data request signal and the identification information transmitted from the typing game apparatus 1, the server CPU 81 stores the identification information received in the server storage area 85 (S101) and shifts to ranking data creation processing (S102).

The ranking data creation processing (S102) will be explained in detail with reference to the drawings. FIG. 10 is a flowchart of a ranking data creation processing program. FIGS. 11A and 11B are diagrams for explaining the ranking data creation processing.

When the server CPU 81 shifts to the ranking data creation processing (S102), the server CPU 81 sorts all song data stored in the song DB 85a on the basis of the data on the number of times of use (S111).

The processing will be explained according to a specific example. It is assumed that song data for twelve tunes in total from a song (A) to a song (L) are stored in the song DB 85a as shown in FIG. 11A. The data on the number of times of use and the data on the number of apparatuses using song data are associated with the song (A) to the song (L), respectively. For example, “230” and “42” are associated with the song data of the song (D) as the data on the number of times of use and the data on the number of apparatuses using song data, respectively.

Therefore, in S111, the server CPU 81 sorts the respective song data in order from one with the largest number of times of use with reference to the data on the number of times of use of the respective song data of the song (A) to the song (L). When the song data shown in FIG. 11A are sorted, the song data are sorted in order from one with the largest number of times of use of data as sown in FIG. 11B. Consequently, the song data stored in the song DB 85a are ranked on the basis of the number of times of use.

When the server CPU 81 shifts to S112, the server CPU 81 judges whether song data having the same number of times of use as other song data is present in all the song data stored in the song DB 85a. When the song data having the same number of times of use are present (YES at S112), the server CPU 81 shifts to S113. In S113, the server CPU 81 ranks the song data having the same number of times of use on the basis of the number of apparatuses using song data. After ranking the song data having the same number of times of use on the basis of the number of apparatuses using song data in the song data stored in the song DB 85a, the server CPU 81 returns to S112.

On the other hand, when song data having the same number of times of use as other song data is not present (NO in S112), the server CPU 81 shifts to S114.

By performing the processing from S1 to S113 in this way, it is possible to rank all the song data stored in the song DB 85a on the basis of a state of use.

The processing from S111 to S113 will be explained in detail on the basis of the specific example with reference to FIGS. 11A and 11B.

As explained above, the song data of the song (A) to the song (L) (twelve songs in total) are stored in the song DB 85a of the server 80 (see FIG. 11A). By executing the processing in S111, the server CPU 81 ranks the song data of the twelve songs in total in order from one having the largest number of times of use (see FIG. 11B).

As shown in FIG. 11B, the data on the number of times of use of the song (C) and the song (D) indicate “230”, respectively. In other words, in this case, the song data having the same number of times of use are present for the song (C) and the song (D) (YES in S112). Since the song (C) and the song (D) have the same number of times of use, it is impossible to judge which of the songs corresponds to the third rank only from the number of times of use. In this case, it is judged which of the song (C) and the song (D) corresponds to the third rank on the basis of the data on the number of apparatuses using song data rather than the number of times of use (S113).

Since the data on the number of apparatuses using song data of the song (C) indicates “45” and the data on the number of apparatuses using song data of the song (D) indicates “42” (see FIG. 11B), it is possible to rank the song (C) as the third rank and the song (D) as the fourth rank.

Returning to S112 again, since the songs excluding the song (C) and the song (D) ranked in the processing described above have different numbers of times of use (NO in S112), the server CPU 81 shifts to S114. This means that ranking for all the songs (A) to (L) stored in the song DB 85a has been completed.

By judging ranking based on states of use of the song data on the basis of both the data on the number of times of use and the data on the number of apparatuses using song data, ranks for all the song data stored in the song DB 85a are associated with one another without repetition.

In S114, as a result of the processing from S111 to S113, ranking data is created on the basis of song data in higher ranks up to the tenth rank among all the song data ranked on the basis of the states of use. For example, in the case of the specific example described above, as shown in FIG. 11B, ranking data is created on the basis of the song data from the song (A) corresponding to the first rank to the song (j) corresponding to the tenth rank (see FIG. 7).

The server CPU 81 stores the ranking data created in this way in the server storage area 85 (S115) and ends the ranking data creation processing (S102).

After ending the ranking data creation processing (S102), the server CPU 81 reads out the ranking data from the server storage area 85 and transmits the ranking data to the typing game apparatus 1, which is a transmission source of the ranking data request signal, on the basis of the identification information stored in the server storage area 85.

On the other hand, when the CPU 10 receives the ranking data transmitted from the server 80, the CPU 10 stores the ranking data received in the HDD 20 (S22).

In S23, the CPU 10 executes, on the basis of the ranking data, recommended download data selection processing for selecting song data recommended to be downloaded.

The recommended download data selection processing (S23) will be explained in detail with reference to the drawings. FIG. 12 is a flowchart of a recommended download data selection processing program.

When the CPU 10 shifts to the recommended download data selection processing (S23), first, the CPU 10 acquires content stored in the song data storage area 20a. In other words, the CPU 10 acquires information indicating the song data stored in the song data storage area 20a (S31).

In S32, the CPU 10 reads out the ranking data stored in the HDD 20 and sets the song data of the first rank in the ranking data as processing object data (S33).

In S34, the CPU 10 judges whether the processing object data is present in the song data storage area 20a. In other words, the CPU 10 judges whether song data set as the processing object data is present on the basis of the content stored in the song data storage area 20a acquired in S31. When the processing object data is not present in the song data storage area 20a (YES in S34), the CPU 10 shifts to S35. On the other hand, when the processing object data is present in the song data storage area 20a (NO in S34), the CPU 10 shifts to S36.

When the processing object data is not present in the song data storage area 20a (YES in S34), the CPU 10 shifts to S35. In S35, the CPU 10 sets the song data, which is set as the processing object data, as recommended download data.

Thereafter, in S37, the CPU 10 judges whether the number of song data set as the recommended download data has reached three. When the number of song data set as the recommended download data is three (YES in S37), the CPU 10 ends the recommended download data selection processing (S23). On the other hand, when the number of song data set as the recommended download data is equal to or smaller than two (NO in S37), the CPU 10 shifts to S38.

In S38, the CPU 10 judges whether the song data corresponding to the tenth rank in the ranking data is processed as the processing object data. In other words, the CPU 10 judges whether processing for all the song data indicated by the ranking data is executed.

When the song data corresponding to the tenth rank is processed as the processing object data (YES in S38), even if three recommended download data is not set, the CPU 10 sets the song data, which is set at the present point, as the recommended download data and ends the recommended download data selection processing (S23).

On the other hand, when the processing for the song data corresponding to the tenth rank is not completed, that is, when the song data set as the recommended download data in S35 correspond to the first rank to the ninth rank in the ranking data (NO in S38), the CPU 10 shifts to S36.

When the song data set as the processing object data is stored in the song data storage area 20a (NO in S34) and when the song data set as the recommended download data in S35 correspond to the first rank to the ninth rank in the ranking data (NO in S38), the CPU 10 shifts to S36. In S36, the CPU 10 changes the processing object data to song data of the next rank in the ranking data.

For example, at present, when the song data corresponding to the third rank in the ranking data is the processing object data and stored in the song data storage area 20a (NO in S34), in S36, the CPU 10 changes the processing object data to the song data corresponding to the fourth rank.

When the processing object data is the song data corresponding to the sixth rank in the ranking data and is not stored in the song data storage area 20a (YES in S34), the song data corresponding to the sixth rank is set as the recommended download data (S35).

At this point, when three recommended download data are not set (NO in S37), since the processing object data is the song data corresponding to the sixth rank (NO in S38), in S36, the CPU 10 changes the processing object data to the song data corresponding to the seventh rank in the ranking data.

The recommended download data selection processing (S23) will be explained in detail according to a specific example on the basis of FIG. 13. FIG. 13 is a diagram for explaining the recommended download data selection processing.

Ranking data shown in a diagram at the top in FIG. 13 is created by the ranking data creation processing (S102) on the basis of the specific example and received by the server 80. In the same manner as the ranking data shown in FIG. 7, the ranking data is formed of the song data of the song (A) to the song (J).

On the other hand, at this point, as shown in a diagram in the center in FIG. 13, it is assumed that song data of five tunes in total of a song (A), a song (C), a song (F), a song (G), and a song (H) are stored in the song data storage area 20a of the typing game apparatus 1.

When the recommended download data selection processing (S23) is executed under this condition, first, in S31 and S32, the CPU 10 acquires content stored in the song data storage area 20a (the figure in the center in FIG. 13) and the ranking data (the figure at the top in FIG. 13).

In S33, the song (A) corresponding to the first rank in the ranking data is set as the processing object data. Since the song (A) is stored in the song data storage area 20a (NO in S34), in S36, the CPU 10 ends the processing for the song (A) and changes the song (B) corresponding to the second rank in the ranking data to the processing object data.

Thereafter, the CPU 10 sets the song (B) as the processing object data and shifts to S34. Since the song data related to the song (B) is not stored in the song data storage area 20a shown in the figure in the center in FIG. 13, the CPU 10 shifts to S35. Therefore, the song (B) is set as the recommended download data. At this point, only the song (B) is set as the recommended download data (NO in S37) and the processing is completed only up to the song data corresponding to the second rank (NO in S38). Thus, the CPU 10 shifts to S36 and sets the song (C) corresponding to the third rank as the processing object data.

By sequentially repeating the processing in this way, in addition to the song (B), the song (D) and the song (E) are selected as the recommended download data. When the song (E) is set as the recommended download data (S35), the number of recommended download data reaches “3”. Since the number satisfies the number of song data that can be delivered by accessing the server 80 once, the CPU 10 ends the recommended download data selection processing (S23).

By executing the processing from S33 to S38 in this way, the CPU 10 sets up to three songs not stored in the song data storage area 20a of the typing game apparatus 1 and having a satisfactory state of use among the song data of ten tunes in the ranking data as the recommended download data. In other words, by receiving delivery of the recommended song data on the basis of the recommended download data, a large number of popular songs are stored in the typing game apparatus 1. Consequently, since it is possible to make the typing game apparatus 1 attractive, an operating ratio of the typing game apparatus 1 is improved. As a result, it is possible to improve profits of a shop in which the typing game apparatus 1 is installed.

Referring back to FIG. 9, concerning the data update processing (S1), processing after the recommended download selection processing (S23) will be explained.

When the recommended download data is selected according to the recommended download data selection processing (S23), the CPU 10 shows the selected recommended download data and displays, on the first liquid crystal display 4, a confirmation display screen (see FIG. 14A) for confirming whether the recommended download data should be downloaded.

The confirmation display screen will be explained in detail with reference to the drawings on the basis of the specified example described above.

As described above, the song data of three tunes of the song (B), the song (D), and the song (E) are displayed as the recommended download data as shown in FIG. 14A. At this point, songs included in the ranking data, not stored in the song data storage area 20a, and not corresponding to the recommended download data are displayed on the confirmation display screen as a song list.

In the case of the specific example (see FIG. 13), the two tunes of the song (I) and the song (J) not stored in the song data storage area 20a and not corresponding to the recommended download data among the song (A) to the song (F) are displayed as a song list (see FIG. 14A).

In this case, an administrator of the typing game apparatus 1 confirms whether the administrator should download the recommended download data by operating the keyboard 3. When the administrator downloads the songs (the song (B), the song (D), and the song (E)) set as the recommended download data, the administrator operates the keyboard 3 to decide download of the songs set as the recommended download data using an “OK button” (YES in S24). At this point, the recommended download data are decided as song data required to be downloaded from the server 80 (hereafter referred to as data required to be downloaded). After deciding the recommended download data as the data required to be downloaded, the CPU 10 shifts to S26.

On the other hand, when the CPU 10 does not decide the recommended download data (NO in S24), the CPU 10 shifts to the download data change processing (S25).

The download data change processing (S25) is processing for changing the songs set as the recommended download data on the confirmation display screen (see FIG. 14A) to the songs displayed in the song list. In this case, the administrator of the typing game apparatus 1 operates the keyboard 3 and designates songs that the administrator desires to change out of the songs set as the recommended download data. Subsequently, the administrator selects songs that the administrator desires to download out of the songs displayed in the song list. By performing the operation, the administrator can change the songs that the administrator desires to change in the recommended download data to the songs that the administrator desires to download.

The download data change processing (S25) will be explained on the basis of the specific example shown in FIGS. 14A and 14B.

As described above, the “song (B)”, the “song (D)”, and the “song (E)” are displayed as the recommended download data and the “song (I)” and the “song (J)” are displayed as the song list on the confirmation display screen (see FIG. 14A).

It is assumed that the administrator of the typing game apparatus 1 desires to download the “song (I)” in the song list rather than the “song (D)” set as the recommended download data.

In this case, in the download data change processing (S25), first, the administrator operates the keyboard 3 and selects the “song (D)” displayed as the recommended download data. Thereafter, the administrator also operates the keyboard 3 and designates the “song (I)” in the song list. By executing this operation, as shown in FIG. 14B, the “song (B)”, the “song (E)”, and the “song (I)” are displayed as songs required to be downloaded and the “song (D)” and the “song (J)” are displayed in the song list. By deciding the song data required to be downloaded, the administrator can download the song data related to the “song (B)”, the “song (E)” and the “song (I)”. After executing change and decision operation for the songs required to be downloaded based on the operation, the CPU 10 ends the download data change processing (S25). After ending the download data change processing (S25), the CPU 10 shifts to S26.

By executing the download data change processing (S25), the administrator of the typing game apparatus 1 is capable of downloading songs different from the songs set as the recommended download data and reflecting a desire of the administrator on the songs. In other words, the administrator is capable of selecting songs to be downloaded on the basis of various situations such as a clientele and regionality of a shop of the administrator. The administrator can reflect a desire of the administrator on the songs while referring to the recommended download data that is information indicating songs with a satisfactory state of use. Thus, it is possible to realize the typing game apparatus 1 as a game apparatus that is adaptable to an environment of use thereof and is attractive.

In S26, the CPU 10 transmits identification information indicating the typing game apparatus 1 together with a download request signal for requesting download of the song data decided as the data required to be downloaded according to the processing in S24 and S25 (S26).

On the other hand, when the server CPU 81 receives the identification signal and the download request signal transmitted from the typing game apparatus 1, the server CPU 81 stores the identification signal in the server storage area 85 (S104). The server CPU 81 reads out song data corresponding to the data required to be downloaded from the song DB 85a on the basis of the download request signal received (S105).

Thereafter, the server CPU 81 specifies the typing game apparatus 1 on the basis of the identification signal stored in the server storage area 85 and transmits the data required to be downloaded (S106). At this point, concerning the song data transmitted to the typing game apparatus 1, the server CPU 81 adds 1 to the data on the number of apparatuses using song data corresponding to the respective song data stored in the song DB 85a.

When the CPU receives the data required to be downloaded requested, the CPU 10 stores the song data downloaded in the song data storage area 20a (S27) and, then, ends the data management processing (S1).

By executing the data update processing (S1) in this way, the song data is added to the typing game apparatus 1. Content stored in the song data storage area 20a when the data update processing (S1) ends will be explained on the basis of the specific example with reference to the drawings.

As described above, before execution of the data update processing (S1), the song data of five tunes in total of the song (A), the song (C), the song (F), the song (G), and the song (H) are stored in the song data storage area 20a (see the figure in the center in FIG. 13).

By executing the data update processing (S1), the song (B), the song (D), and the song (E) are set as the recommended download data. When the songs set as the recommended download data are downloaded, the song data of eight tunes in total of the song (A) to the song (H) are stored in the song data storage area 20a.

In other words, by executing the data update processing (S1), eight tunes in higher ranks in the ranking data (see FIG. 7) ranked in order from one with the best state of use are stored in the song data storage area 20a. Therefore, in the typing game apparatus 1, many songs with satisfactory states of use, that is, popular songs are stored in the song data storage area 20a. Thus, it is possible to execute the typing game based on the popular songs. Consequently, it is possible to realize the typing game apparatus 1 as a more attractive game apparatus and attract players' interest to improve an operating ratio. In other words, it is possible to provide players with a new amusement in that it is possible to select a song used in the typing game from a plurality of popular songs. It is possible to provide shops having the typing game apparatuses 1 installed therein with a game apparatus that can easily execute operation for download of popular songs and has high profitability.

On the other hand, when the song (D) among the song (B), the song (D), and the song (E) set as the recommended download data is changed to the song (I) and the song (B), the song (E), and the song (I) are downloaded according to the download data change processing (S25), the song (A), the song (B), the song (C), the song (E), the song (F), the song (G), the song (H), and the song (I) are stored in the song data storage area 20a when the data update processing (S1) is completed.

In other words, it is possible to reflect a desire of the administrator on the songs set as the recommended download data. The administrator is capable of selecting songs to be downloaded on the basis of various situations such as a clientele and regionality of a shop of the administrator. The administrator can reflect a desire of the administrator on the songs while referring to the recommended download data that is information indicating songs with a satisfactory state of use. Thus, it is possible to realize the typing game apparatus 1 as a game apparatus that is adaptable to an environment of use thereof and is attractive.

The typing game processing (S2) to which the CPU 10 shifts after the data management processing (S1) ends will be explained in detail with reference to the drawings. FIG. 16 is a flowchart of the typing game processing program.

When the CPU 10 shifts to the typing game processing (S2), first, in S40, the CPU 10 judges presence or absence of an IC card. The CPU 10 judges whether the IC card is inserted in the card inserting portion 9 on the basis of a detection result of the card sensor 28 disposed inside the card inserting port 9. When the IC card is present in the card inserting port 9 (YES in S40), the CPU 10 shifts to S41. On the other hand, when the IC card is not present in the card inserting port 9 (NO in S40), the CPU 10 shifts to start reception processing (S43).

When the IC card is inserted in the card inserting port 9 (YES in S40), in S41, a question asking “whether content stored in the IC card should be confirmed” is displayed on the first liquid crystal display 4 and it is judged whether data content should be confirmed (S41).

When the player chooses, using the keyboard 3, that the content stored in the IC card is confirmed (YES in S41), the CPU 10 reads out the content stored in the IC card via the card reader/writer 29 and displays the content on the first liquid crystal display 4 (S42). After displaying the content stored in the IC card, the CPU 10 shifts to the start reception processing (S43). On the other hand, when the player chooses, with the key board 3, that the content stored in the IC card is not confirmed (NO in S41), the CPU 10 directly shifts to the start reception processing (S43).

In the start reception processing (S43), the CPU 10 performs processing related to start of execution of the typing game such as initialization of content stored in the RAM 21, processing for receiving coins used in executing the typing game, and environment setting such as selection of difficulty of the typing game.

After ending the start reception processing (S43), the CPU 10 performs song selection processing (S44). In the song selection processing (S44), the CPU 10 performs processing for selecting song data used in the present typing game out of the song data stored in the song data storage area 20a. Specifically, titles and artist names of the songs of all the song data stored in the song data storage area 20a are displayed on the first liquid crystal display 4. The player selects a song using the keyboard 3, whereby song data used in the present typing game is determined.

As an example, when the recommended download data is not changed in the specific example described above, in the song selection processing, song names and artist names of eight tunes indicating the “song (A)”, the “song (B)”, the “song (C)”, the “song (D)”, the “song (E)”, the “song (F)”, the “song (G)”, and the “song (H)” are displayed on the first liquid crystal display 4. The player selects and determines a song used in the present typing game out of the songs using the keyboard 3.

After the song used in the typing game is determined according to the song selection processing (S44), the CPU 10 shifts to typing game execution processing (S45). The typing game execution processing (S45) is processing related to progress of the typing game. Since the typing game execution processing (S45) will be explained in detail later, an explanation of the processing in this section is omitted. After ending the typing game execution processing (S45), the CPU 10 shifts to S46.

In S46, the CPU 10 executes use information communication processing. The use information communication processing (S46) is processing for communicating information on use of the song data used in the typing game execution processing (S45).

Briefly explaining the use information communication processing, after the typing game execution processing (S45), first, the CPU 10 transmits use information indicating the song data used in the typing game execution processing (S45) to the server 80. The server CPU 81 performs processing for adding 1 to the data on the number of times of use of the song data indicated by the use information. The use information communication processing will be explained in detail later with reference to the drawings.

After the use information communication processing (S46), the CPU 10 executes game result display processing (S47). In the game result display processing, basically, a detailed game result is displayed. The game result is calculated from factors such as an entry mistake of key entry in the typing game performed in the typing game execution processing (S45) and shift of entry timing from the judgment criteria data forming the song data.

After the game result display processing (S47), in S48, the CPU 10 judges whether an IC card is inserted in the card inserting port 9. When the IC card is inserted in the card inserting port 9 (YES in S48), the CPU 10 records the game result of the present typing game in the IC card via the card reader/writer 29 (S49). After recording the game result in the IC card, the CPU 10 ends the typing game processing (S2).

On the other hand, when the IC card is not inserted in the card inserting port 9 (NO in S48), the CPU 10 does not record the present game result in the IC card, erases the game result from the RAM 21, and ends the typing game processing (S2).

It is assumed that the typing game according to this embodiment includes three stages in one game (one tune). For example, when a song selected as song data consists of parts 1 to 3, the part 1 is set as a “first stage”, the part 2 is set as a “second stage”, and the part 3 is set as a “third stage”.

The typing game execution processing (S45) executed in S45 during the typing game processing (S2) will be explained in detail with reference to the drawings. FIG. 17 is a flowchart of a typing game execution processing program. FIGS. 18A and 18B are diagrams for explaining an example of display of the respective liquid crystal displays during execution of the typing game.

As shown in FIG. 14, when the typing game execution processing program is executed, first, the CPU 10 reads out song data corresponding to the song selected according to the song selection processing (S44) out of the song data stored in the song data storage area 20a (S51). In this case, lyrics data forming the song data is divided for each phrase and temporarily stored in the RAM 21.

Subsequently, in S52, the CPU 10 causes the first liquid crystal display 4 to display a main game screen (see FIG. 18B). At this point, a character string (a Japanese representation and a Roman representation) shown in FIG. 18B is not displayed and an indication of a score is “0”.

In S53, the CPU 10 starts display of a PV related to the selected song on the second liquid crystal display 5 on the basis of image data forming the song data (see FIG. 18A). The CPU 10 outputs music of an accompaniment based on performance data forming the song data and outputs voices based on voice data forming the song data via the speakers 7. Consequently, the song is played and the PV is reproduced according to the songs.

In S54, the CPU 10 acquires lyrics for one phrase of the lyrics data stored in the RAM 21 and displays a character string corresponding to the lyrics for the one phrase in a Japanese representation and a Roman representation according to a tempo of the performance of the song. Consequently, the main game screen is displayed on the first liquid crystal display 4 in parallel with the performance of the song and the display of the PV on the second liquid crystal display 5 (see FIG. 18B).

Display forms of the first liquid crystal display 4 and the second liquid crystal display 5 during execution of the typing game will be explained with reference to FIGS. 18A and 18B. In the case shown in FIGS. 18A and 18B, the “song C” is selected in the song selection processing (S44). Therefore, in the typing game apparatus 1, the typing game is executed on the basis of the song data (C) related to the “song (C)”. In this case, the “song data (C)” is song data of a song “ABC” sung by a male artist “AAAA”.

Therefore, when the typing game using the “song data (C)” is executed, a PV of the song (a video such as a state or the like of singing by the male artist “AAAA”) shown in FIG. 18 is displayed on the first liquid crystal display 4. A game screen of the typing game and one phrase (MOU MAYOWANAI in Japanese and Roman representations) of lyrics of the music “ACB”, which should be entered at that point, is displayed on the second liquid crystal display 5 (S54).

Thereafter, in S55, the CPU 10 calculates the number of characters n of the one phrase on the basis of the acquired lyrics data of the one phrase (S55) and substitutes 0 in an arbitrary variable m stored in the RAM 21 (S56). The arbitrary variable m is a variable used for character entry judgment for the respective characters forming the one phrase and is incremented by one every time the entry judgment for one character ends (S63). Therefore, in entry judgment processing repeated in S57 to S64 described below, when m=t(0≦t≦n−1), entry judgment for a (t+1)th character from the top of the one phrase is performed.

In S57, the CPU 10 judges whether key entry by character entry keys is performed on the basis of an operation signal from the keyboard 3. When it is judged that the key entry is performed (YES in S57), the CPU 10 performs right/wrong judgment processing of the depressed key on the basis of a type of the key depressed and judgment criteria data forming the song data (S58). Specifically, explaining the case shown in FIG. 18 as an example, the one phrase of the lyrics (MOU MAYOWANAI in Japanese and Roman representations) is displayed on the main game screen and, at this point, key entry for “M”, “0”, and “U” is performed. Therefore, when a key corresponding to “M” in the Roman representation is depressed, it is recognized that correct typing is performed. When it is judged that a key other than the corresponding key is depressed, the number of times of mistake is incremented by one. Thereafter, the CPU 10 shifts to S61.

On the other hand, when it is judged that no key entry is performed (NO in S57), the CPU 10 judges, on the basis of the timer 30, whether a predetermined time (in entering a top character of the one phrase, measured after displaying the character string corresponding to the one phrase on the first liquid crystal display 4 (S54) and, in inputting other characters, measured after performing score calculation processing (S62)) has elapsed (S59). When it is judged that the predetermined time has not elapsed (NO in S59), the CPU 10 returns to the judgment processing in S57.

On the other hand, when it is judged that the predetermined time has elapsed (YES at S59), considering that key entry by the player is not performed, the CPU 10 increments the number of times of mistake in the present entry object character (“M” in the specific example described above) stored in the RAM 21 by one (S60).

Subsequently, in S61, the CPU 10 performs light emission processing for keys on the basis of the LEDs 302 provided inside the keys of the keyboard 3. Specifically, in the typing game apparatus 1 according to this embodiment, when key entry is performed (YES in S57) and it is judged that correct typing is performed, the CPU 10 causes the depressed key 300 to emit light in blue. When key entry is performed (YES in S57) and it is judged that wrong typing is performed, the CPU 10 causes the depressed key 300 and the correct key 300 that should be depressed to emit light in red and green, respectively. Moreover, when there is no key entry (NO in S57), the CPU 10 causes the correct key 300 that should be depressed to emit light in green.

In S62, the CPU 10 performs score calculation processing on the basis of the right/wrong judgment processing (S58). In the score calculation processing (S62), when it is judged in the right/wrong judgment processing that correct typing is performed, the CPU 10 adds a point to a score of the player in the present game stored in the RAM 21 on the basis of the key entry. When it is judged that a corresponding character is typed at identical timing as a voice of a song performed, the CPU 10 further adds a point to the score.

Thereafter, in S63, the CPU 10 reads out the variable m stored in the RAM 21, adds “1” to the variable m, and stores the variable m in the RAM 21 again. Subsequently, in S64, the CPU 10 judges whether a value of the variable m has reached n−1, that is, whether the character entry judgment for all the characters forming the one phrase ends.

When it is judged that the value of the variable m has not reached n-1 (NO in S64), the CPU 10 returns to S57 and performs the character entry judgment for a character next in the order among the characters forming the one phrase.

On the other hand, when it is judged that the value of the variable m has reached n−1 (YES in S64), since this means that entry of the characters of the one phrase is completed, in S65, the CPU 10 performs point addition processing. In the point addition processing, when it is judged that entry is completed without mistyping of the n characters forming the one phrase (including the judgment on mistype according to elapse of the predetermined time (S60)), the CPU 10 adds one point. This point is added to the score when the typing game ends. Therefore, in order to acquire a high score, it is important to execute the typing game such that this point can also be acquired.

In S66, the CPU 10 judges whether entry judgment for phrases at a stage corresponding to any part number of plural part numbers forming the song (usually, one tune is formed of parts 1 to 3) ends. When it is judged that the entry judgment for all phrases at one stage does not end (NO in S66), the CPU 10 returns to S54, acquires lyrics of the next phrase from the RAM 21, and displays the lyrics on the main game screen (the first liquid crystal display 4).

On the other hand, when it is judged that the entry judgment for all the phrases at one stage ends (YES in S66), the CPU 10 continuously judges whether the entry judgment for phrases at all the stages (all the tunes of the song) ends (S67).

When it is judged that the entry judgment for phrases at all the stages ends (YES in S67), the CPU 10 ends the typing game execution processing (S45) and shifts to the use information communication processing (S26). On the other hand, when it is judged that the entry judgment for phrases at all the stages does not end (NO in S67), the CPU 10 judges whether the number of times of mistype by the player up to now added in S58 and S60 is less than a predetermined number of times (S68).

In the typing game apparatus 1 according to this embodiment, the typing game consists of plural stages according to the part numbers of a song to be reproduced. At a point when one stage ends, there are factors such as entry mistake of key entry of the next part number and shift of entry timing from judgment criteria data forming song data. Because of such factors, as a condition for continuing to perform the stages, the number of times of mistype from the start of the play has to be less than the predetermined number of times (e.g., in order to continue to perform the stage corresponding to the part 2 after playing the stage corresponding to the part 1, the number of times of mistype has to be less than twenty and, in order to continue to perform the stage corresponding to the part 3 after playing the stage corresponding to the part 2, the number of times of mistype has to be less than thirty-five).

When it is judged that the number of times of mistype by the player added in S58 and S60 is less than the predetermined number of times (YES in S68), the CPU 10 returns to S54, acquires lyrics corresponding to a first phrase of the next part number from the RAM 21, and displays a character string corresponding to the phrase on the first liquid crystal display 4. The CPU 10 performs the entry judgment processing in the same manner. On the other hand, when it is judged that the number of times of mistype by the player is equal to or larger than the predetermined number of times (NO in S68), the CPU 10 ends the typing game execution processing (S45) and shifts to the use information communication processing (S46).

The use information communication processing (S46) executed in the typing game processing will be explained with reference to the drawings. FIG. 19 is a flowchart of a use information communication processing program.

After ending the typing game execution processing (S45), the CPU 10 shifts to the use information communication processing (S46). The CPU 10 transmits use information indicating the song data used in the typing game execution processing (S45) to the server 80 via the game communication section 25 (S70).

When the server 80 receives the use information, the server CPU 81 stores the use information received in the server storage area 85 (S121). The server CPU 81 specifies the used song data on the basis of the use information stored in the server storage area 85 and adds “1” to the data on the number of times of use of the song data stored in the song DB 85a (S122).

By executing the use information communication processing (S46) in this way, the number of times of use of the song data stored in the song DB 85a is updated every time the song data is used in the typing game apparatus 1 constituting the game system 100. Consequently, the ranking data transmitted in the data update processing (S1) is latest ranking data of a state of use of songs in the game system 10 at a point when the typing game apparatus 1 requests ranking data. Therefore, in the recommended download data selection processing (S23), recommended download data is selected according to the ranking data based on the latest state of use.

As a result, the administrator of the typing game apparatus 1 can easily grasp, in the latest ranking data, song data with a satisfactory state of use, that is, song data gaining popularity at the present point. It is possible to realize the typing game apparatus 1 that can store a plurality of songs gaining popularity at the present point as occasion arises by downloading the song data and execute the typing game using the songs.

As described above, the typing game apparatus 1 in the game system 100 according to this embodiment can execute the data update processing (S1) for downloading song data used for execution of the typing game from the server 80 via the game communication section 25. Before executing the download of the song data, the typing game apparatus 1 receives, from the server 80, delivery of ranking data in which respective songs are ranked on the basis of the data on the number of times of use and the number of apparatuses using song data.

In the recommended download data selection processing (S25), the typing game apparatus 1 having received the ranking data selects song data of most popular three tunes, which is not stored in the song data storage area 20a of the typing game apparatus 1, as recommended download data with reference to the ranking data received.

By downloading song data on the basis of the recommended download data, at least song data of three tunes gaining highest popularity is stored in the song data storage area 20a.

Therefore, for example, when the typing game apparatus 1 is in an initial state in which song data is not stored in the song data storage area 20a, song data corresponding to the first rank to the third rank in the ranking data are delivered.

If song data corresponding to the second rank, the fourth rank, and the fifth rank in the ranking data are stored in the song data storage area 20a at the present point, song data corresponding to the first rank, the third rank, and the sixth rank in the ranking data are delivered. In this case, when the data update processing (S1) ends, the song data corresponding to the first rank to the sixth rank in the ranking data are stored in the song data storage area 20a.

In this way, in the typing game apparatus 1, many songs with satisfactory states of use, that is, popular songs are stored in the song data storage area 20a. Thus, it is possible to execute the typing game based on the popular songs. Consequently, it is possible to realize the typing game apparatus 1 as a more attractive game apparatus and attract players' interest to improve an operating ratio. In other words, it is possible to provide players with a new amusement in that it is possible to select a song used in the typing game from a plurality of popular songs. It is possible to provide shops having the typing game apparatuses 1 installed therein with a game apparatus that can easily execute operation for download of popular songs and has high profitability.

In the typing game apparatus 1 according to this embodiment, it is possible to change song data set as recommended download data to different song data according to the download data change processing. Consequently, the administrator is capable of selecting songs to be downloaded on the basis of various situations such as a clientele and regionality of a shop of the administrator. The administrator can reflect a desire of the administrator on the songs while referring to the recommended download data that is information indicating songs with a satisfactory state of use. Thus, it is possible to realize the typing game apparatus 1 as a game apparatus that is adaptable to an environment of use thereof and is attractive.

In the server 80 constituting the game system 100 according to this embodiment, every time song data is delivered to the typing game apparatus 1, 1 is added to the data on the number of apparatuses using song data related to the song data delivered.

In the typing game apparatus 1, every time the typing game is executed and song data is used, the use information communication processing (S46) is executed. Consequently, user information indicating that the song data is used in the typing game apparatus 1 is transmitted to the server 80. In the server 80, 1 is added to the data on the number of times of use related to the song data used in the typing game apparatus 1 on the basis of the use information.

According to execution of these kinds of processing, the data on the number of times of use and the number of apparatuses using song data used in the ranking data creation processing (S102) are updated as occasion arises. Therefore, it is possible to transmit ranking data based on a latest state of use at a point when ranking data is requested by the typing game apparatus 1.

Since recommended download data is selected according to the latest ranking data, it is possible to sensitively cope with the current of the times. In other words, the administrator of the typing game apparatus 1 does not always need to be attentive to a trend of songs but can easily cope with the current of the times by referring to song data selected as the recommended download data. Consequently, in the typing game apparatus 1, it is always possible to execute the typing game with a popular song corresponding to the current of the times. Thus, an operating ratio of the typing game apparatus 1 increases. According to the increase in an operating ratio, it is possible to increase profits generated from the typing game apparatus 1.

The invention is not limited to the embodiment. Various modifications of the invention are possible within a range not departing from the spirit of the invention. For example, in the game system 100 according to this embodiment, the plurality of typing game apparatuses 1 and the server 80 are directly connected to each other through the network N. However, connection between the typing game apparatuses 1 and the server 80 is not limited to this form. For example, in a shop in which the plurality of typing game apparatuses 1 are installed, it is also possible that a management server that manages the typing game apparatuses 1 installed in the shop is provided between the typing game apparatuses 1 and the server 80 and connected to the server 80 through the network N.

In this embodiment, the single sever 80 is used. However, a center server system including a plurality of servers may be adopted.

In this embodiment, song data are ranked on the basis of the data on the number of times of use and the data on the number of apparatuses using song data to generate ranking data. However, data referred to in ranking the song data are not limited to these data. For example, as in this embodiment, when the song data is “data of a song sung by an artist”, it is also possible to rank the song taking into account factors such as the number of sales of CDs of the song and ranking announced on the television, the radio, and the like.

In this embodiment, songs corresponding to top ten ranks among songs ranked according to states of use are delivered as ranking data. However, songs to be delivered as ranking data are not limited to those corresponding to the top ten ranks. For example, when ranking data of songs corresponding to top one hundred ranks is delivered, in changing the recommended download data to another song in the download data change processing (S25), a range of selection of changeable songs increase. Thus, it is possible to reflect an intention of the administrator on the songs more. It is possible to realize content stored in the song data storage area 20a that is adaptable to an environment of use of the typing game apparatus 1.

In this embodiment, the recommended download data selection processing (S23) is executed in the typing game apparatus 1. However, the recommended download data selection processing may be executed in the server 80.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A game apparatus comprising:
a display section that display images;
a storage section that stores data related to a game including song data;
a game controller that controls progress of the game based on the song data;
a communication section that makes connection to a server in which a plurality of song data are stored to be deliverable;
an operation section on which operation related to the game is performed; and
a request signal transmitting section that transmits a request signal for delivery of song data, which corresponds to a high rank in ranking data in which song data are ranked on the basis of a predetermined condition, among song data not stored in the storage section to the server.

2. A game system comprising:
the game apparatus according to claim 1; and
a server having a server communication section that allows to transmit data to and receive data from the game apparatus and a storage device having stored therein the plurality of song data,
wherein the game apparatus transmits information on use of the song data to the server via the communication section according to execution of the game based on the song data,
the server includes:
a ranking data creating section that creates the ranking data on the basis of information on use of the song data stored in the storage device; and
a song data delivering section that delivers requested song data on the basis of the request signal.
